(19) United States
(12) Patent Application Publication
(10) Pub. No.: US 2016/0130403 A1
(43) Pub. Date: May 12, 2016

(54) SILICONE CO-POLYMERS AND METHODS OF USE THEREOF TO MODIFY THE SURFACE OF SILICONE ELASTOMERS BY PHYSICAL ADSORPTION

(71) Applicants: Yang CHEN, Ancaster (CA); McMaster University, Hamilton (CA)

(72) Inventors: Michael A. Brook, Ancaster (CA); Yang Chen, Ancaster (CA)

(73) Assignee: McMaster Unviersity, Hamilton (CA)

(21) Appl. No.: 14/895,539

(22) PCT Filed: Jun. 6, 2014
(86) PCT No.: PCT/CA2014/050526

§ 371 Date: Dec. 3, 2015

Related U.S. Application Data
(60) Provisional application No. 61/831,814, filed on Jun. 6, 2013.

(51) Int. Cl. C08G 77/38

(52) U.S. Cl. CPC C08G 77/38

(57) ABSTRACT

The present application relates to polymers of Formula (I) and (II) which, when combined with a silicone elastomer or a silicone pre-elastomer, modifies the surface properties of the elastomer, for example by making the elastomer surface more hydrophilic or reactive to other compounds resulting in the functionalization of the elastomer surface. Methods of using the polymers and silicone elastomers coated with the polymers are also included in the application.

### CROSS-REFERENCE TO RELATED APPLICATIONS

The present application claims the benefit of priority from U.S. Provisional Application No. 61/831,814 filed on Jun. 6, 2013. The entire text of the above-referenced application is specifically incorporated herein by reference.

### FIELD

The present application broadly relates to polymers that when mixed with silicone elastomers, modify the surface properties of the silicone elastomer. More specifically, but not exclusively, the present application relates to polymers for rendering the surface of silicone elastomers hydrophilic or reactive to nucleophiles. The present application also relates to a process for physically adsorbing a polymer onto the surface of a silicone elastomer to provide surface-modified silicone elastomers.

### BACKGROUND

Silicone polymers, particularly, polydimethylsiloxane (PDMS), are widely used elastomeric materials due to their characteristics, which include optical transparency, high flexibility, low biological activity, ease of fabrication, excellent control over hardness, the ability to take complex shapes in molds, etc. The high hydrophobicity of silicones can be advantageous in many applications, but typically not those that involve linking to other materials or applications that require wettability by water. For such applications, silicone surface chemistry normally needs to be manipulated.

A number of methods have been developed to create hydrophilic PDMS surfaces. One strategy employs high-energy treatments, such as a plasma,^{[1]} ultraviolet light,^{[2]} or corona discharge to modify the surface.^{[3]} Depending on the conditions, functional groups, typically hydroxy groups, are introduced onto the PDMS surface. Alternatively, the surface can be modified by chemical treatment including etching or oxidization with reagents such as a H₂O/H₂O₂/HCl mixture^{[4]} or concentrated NaOH,^{[5]} KOH or tetrabutylammonium fluoride trihydrate (TBAF).^{[6]} If other silicone species are present during reactions of this type, it is possible to incorporate functional silicone monomers at the interface. For example, metathesis of a silicone elastomer surface with the functional polymer (MeHSiO)ₙ in the presence of triflic acid leads to surfaces rich with SiN groups.^{[7]} In some cases, surface modification with these methods is accompanied by notable degradation of the surfaces as evidenced by increased roughness, or cracks.^{[8]}

An alternative strategy to create hydrophilic silicones involves grafting hydrophilic polymers to the surface. For example, allyl^{[7]} or vinyl-terminated poly(ethylene glycol)(PEG) can be attached to silicon hydride-functionalized PDMS surfaces, described above, by hydrosilylation.^{[9]} The PEG groups may additionally possess functional groups susceptible to substitution (tosylate)^{[10]} or addition (activated NHS esters)^{[7]} that can be used to anchor polar molecules to the surface. Other methods of connecting silicones to hydrophilic polymers are possible including click cyclization chemistry that leads to chemical grafting of polar polymers like PEG to the silicone surface.^{[11]} Polymerization from the surface also leads to polymer-modified silicones. For example, methacrylate monomers functionalized with hydrophilic segments (PEG) or groups (amide) were polymerized from an elastomer surface using atom transfer radical polymerization (ATRP) after the initiator was bonded to an oxidized surface.^{[12]}

Surface modification using the processes described above can dramatically increase the wettability of the surface. For example, sessile water drop advancing contact angles can be reduced to 0° using oxidation^{[13]} and 30-40° with PEG grafting to the silicone surface under optimal conditions.^{[11]} However, such hydrophilic surfaces are not permanent. As a consequence of very flexible polymer chains (low Tg) and very low surface energy, the silicone chains can migrate past the introduced hydrophilic groups to the air interface, where they are thermodynamically favored: both tethered and free silicones can migrate to cover the modified layer.^{[14]} Eventually, the surface loses hydrophilicity, that is returns to a hydrophobic state, in a process coined “hydrophobic recovery” or “surface reversion.”^{[15]} Permanently hydrophilic or functional silicones are difficult to make even when using the techniques described above.

An example of permanently hydrophilic silicone surfaces is described in US Patent Application Publication No. 2012/0226001.^{[16]} In this system a small silicone hydrophobic group is chemically tethered to a silicone elastomer surface through a short PEG chain (typically 6-10 monomer units long). The permanent nature of the surface modification, because of the covalent linkage, is advantageous. However, the process for manufacture is complex and requires the introduction of SiH groups into or onto the silicone elastomer. In the former case, residual SiH groups can undergo crosslinking over time leading to changes in elastomer modulus. In the latter case, controlling the surface density of SiH groups is not straightforward and involves several steps that are not convenient in constrained channels, for example, in a microfluidics-based device.

A variety of applications in which silicones would otherwise be ideal suffer from hydrophobic surfaces. For example, silicone elastomers used to seal junctions between architectural concrete panels often collect dirt because of their hydrophobic nature. More wettable materials could be self-cleaning. The arena of microfluidics could also benefit from hydrophilic surfaces. This field of science commonly utilizes silicone elastomers into which small channels have been (in most cases) molded. High surface to volume ratios of the microfluidic channels make it difficult to pass aqueous fluids, which carry analytes, through the materials.^{[17]} A variety of strategies related to those described above have been adopted to overcome this challenge, including the use of pumping devices.^{[18]} Surface treatments including plasma etching^{[19]} or polymerization,^{[20]} deposition of silica,^{[21]} however, are generally neither efficient when performed on existing channels, as opposed to surface manipulation prior to device manufacture, nor do they overcome the problems of hydrophobic reversion over extended periods of time.^{[22]}

### SUMMARY

The present application broadly relates to polymers that when mixed with silicone elastomers, modify the surface properties of the silicone elastomer. In one aspect, the present application relates to polymers for rendering the surface of silicone elastomers hydrophilic or reactive to nucleophiles. In a further aspect, the present application relates to a process for physically adsorbing a polymer onto the surface of a silicone elastomer providing surface-modified silicone elastomers or pre-elastomers.

In an embodiment, the present application includes a compound of the Formula (I) or (II)

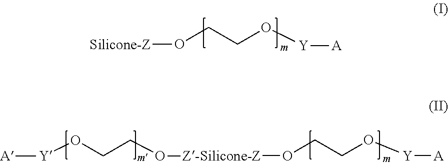

wherein:
m and m′ are, independently, an integer from 2 to 20;
Silicone is a straight or branched chain silicone polymer;
Y is a linker moiety selected from a direct bond, —(CH₂)ₚ—, —(CH₂)_{p′}S—(CH₂)ₚ—, —C(O)—, —(CH₂)ₚC(O)—, —C(O)O—, —C(O)NH—, —(CH₂)ₚO —, —(CH₂)ₚC(O)O—, —(CH₂)ₚOC(O)—, —(CH₂)ₚOC(O)O— and —(CH₂)ₚOC(O)NH—;
Y′ is a linker moiety selected from a direct bond, —(CH₂)_{p′}—, —(CH₂)_{p′}S—(CH₂)ₚ—, —C(O)—, —C(O)(CH₂)_{p′}—, —OC(O)—, —NHC(O)—, —O(CH₂)_{p′}—, —C(O)O(CH₂)_{p′}—, —OC(O)(CH₂)_{p′}, —OC(O)O(CH₂)_{p′}- and —NHC(O)(CH₂)_{p′}—;
Z is a linker moiety selected from —(CH₂)ₙ—, —(CH₂)_{n′}S—(CH₂)ₙ—, —(CH₂)ₙtriazoleC(O)—, —(CH₂)ₙC(O)—, —O(CH₂)ₙ—, —(CH₂)ₙOC(O)—, and —OC(O)(CH₂)ₙ—;
Z′ is a linker moiety selected from —(CH₂)_{n′}—, —(CH₂)_{n′}S—(CH₂)ₙ—, —C(O)triazole(CH₂)_{n′}—, —C(O)(CH₂)_{n′}—, —(CH₂)_{n′}O—, —C(O)O(CH₂)_{n′}—, —(CH₂)_{n′}C(O)O—;
n and n′ are, independently, an integer from 1 to 6;
p and p′ are, independently, an integer from 1 to 6;
A and A′ are independently selected from C₁₋₂₀alkyl, a trisiloxane, a tetrasiloxane, a pentasiloxane, a hexasiloxane, a heptasiloxane, a functional group that is displaceable by a nucleophile or an electrophile and

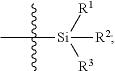

and
R¹, R² and R³ are, independently, selected from C₁₋₂₀alkyl, C₃₋₁₄ cycloalkyl and C₆₋₁₄aryl.

In an embodiment of the present application, Y-A and Y-′A′ are, independently R⁴C(O) and R^{4′}C(O).

In an embodiment of the present application, A and A′ are activating groups that react with reactive functionalities on one or more biological molecules so that the one or more biological molecules become covalently attached to compound of the formula (I) or (II).

In a further embodiment of the present application, R⁴ and R^{4′} are, independently, activating groups that react with nucleophilic functionalities on one or more biological molecules so that the one or more biological molecules become covalently attached to the carbonyl group. In a further embodiment of the present application, the R⁴ and R^{4′} group are a N-hydroxysuccinimidyl (NHS) group:

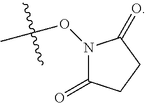 [SMILES: *ON1C(=O)CCC1=O]

Also included within the scope of the present application is a compound of formula

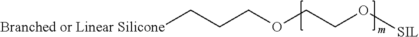

wherein
m is 6, 7, 8, 9 or 10;
SIL is selected from one of the following structures

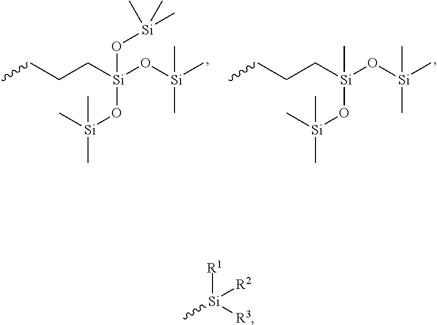

and
wherein R¹, R², R³ may be the same or different, may not be a radically polymerizable alkene, and may be selected from Ph, Me, Et, nPr, iPr, tBu, and the Linear Silicone has the formula (D):

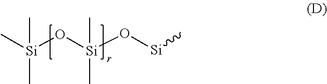

where r=2-13 and [symbol] represents the point of attachment of the group or the Branched Silicone is chosen from one of the following structures

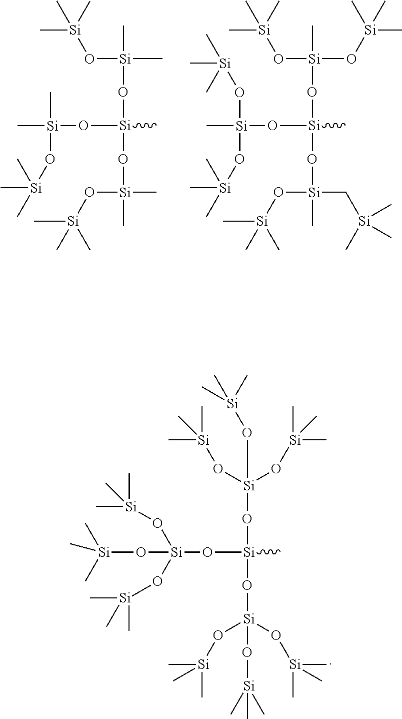

In this embodiment, SIL refers to a silicon hydrophobe which includes embodiments equivalent to Y-A and Y′-A′.

Also included within the scope of the present application is a compound of formula

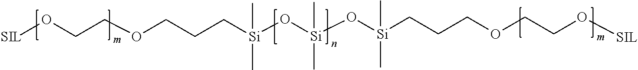

wherein
m is 6, 7, 8, 9 or 10;
n is 10, 11, 12, 13, 14, 15, or 16;
SIL is selected from one of the following structures

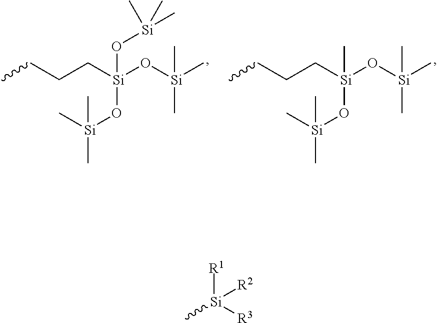

wherein R¹, R², R³ may be the same or different, may not be a radically polymerizable alkene, and may be selected from Ph, Me, Et, nPr, iPr, tBu.
   In this embodiment, SIL refers to a silicon hydrophobe which includes embodiments equivalent to Y-A and Y′-A′.

The present application also includes a process for surface modifying a silicone elastomer, the process comprising:
(a) soaking a silicone elastomer in a solution or dispersion of one or more compounds of the formula (I) or (II) as defined herein under conditions to produce a swollen elastomer; and
(b) drying the swollen silicone elastomer to produce a surface-modified silicone elastomer.

The present application also includes a further process for surface modifying a silicone elastomer, the process comprising:
(a) mixing one or more compounds of the formula (I) or (II) as defined herein, either neat or as a dispersion or solution, with a pre-cured silicone elastomer; and
(b) allowing the mixture of pre-cured silicone elastomers and compounds of the formula (I) or (II) to cure.

The present application also includes a silicone elastomer that has been surface-modified by grafting of one or more compounds of formula (I) or (II) as defined herein onto its surface. In an embodiment, the silicone elastomer is PDMS. In an embodiment, the silicone elastomer has been surface-modified to have a water contact angle of 30° or less.

The present application also includes a silicone elastomer that has been surface-modified by incorporating one or more compounds of formula (I) or (II) as defined within the pre-cured mixture and allowing the mixture to cure. In an embodiment, the substrate is PDMS. In an embodiment, the substrate has been surface-modified to have a water contact angle of 30° or less.

The present application also includes a method of modifying a surface of a silicone elastomer substrate by swelling the compound of the application in a good solvent for silicones, including DCM, THF, toluene, allowing the compound to penetrate the elastomer, evaporating the solvent and washing the modified elastomer surface with water.

The present application also includes a substrate that has been surface modified by adsorption of one or more compounds of Formula (I) or Formula (II) on to its surface. In an embodiment, the substrate has a water contact angle of about 20° or less.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF THE DRAWINGS/FIGURES

In the appended drawings/figures:

FIGS. 1A, 1B and 1C are schemes showing methods that can be used for the preparation of monofunctional silicones in accordance with embodiments of the present application.

FIGS. 2A, 2B and 2C are schemes showing methods that can be used in the preparation of mono-Y-A or mono-Y′-A′ functionalized PEG in accordance with embodiments of the present application.

FIG. 3 shows selected Y-A and Y′-A′ groups in accordance with an embodiment of the present application.

FIGS. 4A and 4B are schemes showing methods that can be used in the preparation of selected wetting block surfactants of Formula I in accordance with embodiments of the present application.

FIGS. 5A and 5B are schemes showing methods that can be used in the preparation of selected wetting block surfactants of Formula II in accordance with embodiments of the present application.

FIG. 6 is an illustration of selected branched silicones in accordance with an embodiment of the present application.

FIG. 7 is graph showing the of the effect of tBS-PEG₆₋₈-(Me₂SiO)₁₂₋₁₄-PEG₆₋₈-tBS concentration on wetting behavior in accordance with an embodiment of the present application.

FIG. 8A is a graph showing the static contact angles of PDMS surfaces: as-treated; soaked in water for 2 days; stored in air for 12 months and stored in air for 12 months then re-hydrated in accordance with an embodiment of the present application. FIG. 8B is a graph showing the contact angle change after a period of time following soaking the tBS-PEG₆₋₈-(Me₂SiO)₁₂₋₁₄-PEG₆₋₈-tBS surfactant treated PDMS in water in accordance with an embodiment of the present application.

FIG. 9 is schematic showing the physical grafting process in accordance with an embodiment of the present application: (left) silicone elastomer in THF solution of surfactant; (middle) silicone elastomer swollen in solution; and (right) silicone elastomer after removal of solvent under vacuum.

FIG. 10 is a graph showing the effect of the PDMS block length on wettability in accordance with an embodiment of the present application.

FIG. 11 is graph showing the effect of concentration of Laurate-PEG-PDMS-PEG-Laurate on static contact angle of PDMS using the swelling method in accordance with an embodiment of the present application.

FIG. 12 is a graph showing the contact angle of DBTL-tin cured RTV cured PDMS blend with varying concentrations of a compound of application (Laurate-PEG-PDMS-PEG-Laurate or tBS-PEG-PDMS-PEG-tBS).

FIG. 13 is a graph showing the contact angle of Sylgard 184 blend with varying concentrations of a compound of application (Laurate-PEG-PDMS-PEG-Laurate or tBS-PEG-PDMS-PEG-tBS).

### DETAILED DESCRIPTION

(i) Glossary

In order to provide a clear and consistent understanding of the terms used in the present application, a number of definitions are provided below. Moreover, unless defined otherwise, all technical and scientific terms as used herein have the same meaning as commonly understood by one of ordinary skill in the art to which this application pertains.

The word “a” or “an” when used in conjunction with the term “comprising” in the claims and/or the application may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this application and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±1% of the modified term if this deviation would not negate the meaning of the word it modifies.

The present description refers to a number of chemical terms and abbreviations used by those skilled in the art. Nevertheless, definitions of selected terms are provided for clarity and consistency.

The term “compound of the application” or “compounds of the application as used herein refers to a compound of Formula I and II as defined herein.

As used herein, the term “alkyl” refers to straight-chain or branched-chain alkyl groups. This also applies if they carry substituents or occur as substituents on other groups, for example in alkoxy groups, alkoxycarbonyl groups or arylalkyl groups. Substituted alkyl groups are substituted in any suitable position. Examples of alkyl groups containing from 1 to 20 carbon atoms are methyl, ethyl, propyl, butyl, pentyl, hexyl, heptyl, octyl, nonyl, decyl, undecyl, dodecyl, tetradecyl, hexadecyl, octadecyl, nonadecyl and dodecyl, the n-isomers of all these groups, isopropyl, isobutyl, isopentyl, neopentyl, isohexyl, isodecyl, 3-methylpentyl, 2,3,4-trimethylhexyl, sec-butyl, tert-butyl, or tert-pentyl. A specific group of alkyl groups is formed by the groups methyl, ethyl, n-propyl, isopropyl, n-butyl, isobutyl, sec-butyl and tert-butyl.

As used herein, the term “cycloalkyl” is understood as being a carbon-based ring system, non-limiting examples of which include cyclopropyl, cyclobutyl, cyclopentyl, cyclohexyl, cycloheptyl and cyclooctyl.

As used herein, the term “aryl” is understood as being an aromatic group which comprises a single ring or multiple rings fused together and which is optionally substituted. When formed of multiple rings, at least one of the constituent rings is aromatic. In an embodiment, aryl substituents include phenyl, and naphthyl groups.

The term “substituted” as used herein, means that a hydrogen atom of the designated moiety is replaced with a specified substituent, provided that the substitution results in a stable or chemically feasible compound. Non-limiting examples of substituents include halogen (F, Cl, Br, or I) for example F, and C₁₋₆alkyl.

The term “suitable” as used herein means that the selection of the particular compound or conditions would depend on the specific synthetic manipulation to be performed, and the identity of the molecule(s) to be transformed, but the selection would be well within the skill of a person trained in the art. All process/method steps described herein are to be conducted under conditions sufficient to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

The term “biological molecule” as used herein refers to any molecule known to be found in biological systems and includes, amino acids, proteins, peptides, nucleic acids (including DNA and RNA), alcohols, carboxylic acids, saccharides, polysaccharides and the like. Biological molecules include those which are naturally occurring as well as those which have been modified using known techniques.

The term “biocompatible” as used herein means that the material either stabilizes proteins and/or other biomolecules against denaturation or does not facilitate denaturation. The term “biocompatible” also means compatible with in vivo use, in particular in animal subjects, including humans.

The “nucleophilic functionalities” on the biomolecule may be any nucleophilic group, for example, an amine (NH₂), hydroxy (OH) or thiol (SH) group. In an embodiment of the invention, the “nucleophilic functionality” is an amine (NH₂) or hydroxy (OH) group.

The term “hydrophobic,” as used herein, refers to a tendency to not dissolve (i.e., associate with) readily in water. With respect to a surface, the term “hydrophobic” refers to a surface that has a sessile water drop contact angle of at least 70°.

The term “hydrophilic,” as used herein, refers to a tendency to readily associate with water. With respect to a surface, the term “hydrophilic” refers to a surface that has a sessile water drop contact angle of less than 30°.

The term “siloxane” as used herein refers to a functional group comprised of units of the formula “R^{a}R^{b}SiO”, wherein R^{a} and R^{b} are, independently, an alkyl, alkenyl or aryl group. When R^{a} and R^{b} are methyl, the group is referred to herein as a “methylsiloxane”.

The term “silicone” as used herein refers to a polysiloxane.

The term “silicone elastomer” as used herein refers to a rubber comprised of silicone. In its uncured state, silicone elastomers are a highly-adhesive gel or liquid. In order to convert to a solid, it must be cured, vulcanized or catalyzed. In embodiment, silicone elastomers include silicone polymers that are cross-linked, in the presence of moisture and catalyzed by metal salts such as, in a non-limiting example, the RTV (room temperature vulcanization) polymers prepared by crosslinking hydroxy-terminated polydimethylsiloxane with tri or tetrafunctional silanes, such as, in a non-limiting example Si(OEt)₄, in the presence of catalyst such as, in a non-limiting example, dibutyltin dilaurate. In further embodiments, silicone elastomers also include silicone polymers that are crosslinked by metal catalyzed hydrosilylation, including in a non-limiting example, Sylgard 184, a product of Dow Corning Corporation. In further embodiments, silicone elastomers also include silicone polymers cross-linked using a Lewis acid including (Piers-Rubinsztajn reaction), in a non-limiting example, B(C₆F₅)₃, wherein hydrogen-functional silicones (i.e., containing SiH functional groups) are reacted functional silanes, such as, in a non-limiting example Si(OEt)₄.

The term “pre-cured silicone elastomer” as used herein includes those silicone polymers that, when mixed under the appropriate conditions, utilize room temperature vulcanization, the Piers-Rubinsztajn reaction or hydrosilylation cure technologies.

The term “tBS” as used herein means the group t-butyldimethylsilyl-.

The term “Laurate” as used herein means the group CH₃(CH₂)₁₀C(O)O—.

The term “surfactant” or “surface active compound” as used herein refers to a compound of the application having both hydrophobic groups and hydrophilic groups and that lowers the contact angle between two substances, such as a liquid and a solid or between two liquids, and/or that increases the wettability of a solid, such as a silicone elastomer.

(ii) Compounds of the Application

The present application includes a compound of the formula (I) or (II):

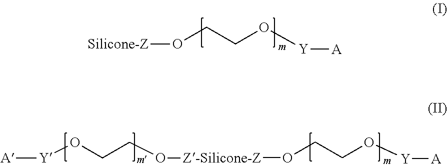

wherein:
m and m′ are, independently, an integer from 2 to 20;
Silicone is a straight or branched chain silicone polymer;
Y is a linker moiety selected from a direct bond, —(CH₂)ₚ—, —(CH₂)ₚS—(CH₂)ₚ—, —C(O)—, —(CH₂)ₚC(O)—, —C(O)O—, —C(O)NH—, —(CH₂)ₚO —, —(CH₂)ₚC(O)O—, —(CH₂)ₚOC(O)—, —(CH₂)ₚOC(O)O— and —(CH₂)ₚOC(O)NH—;
Y′ is a linker moiety selected from a direct bond, —(CH₂)_{p′}—, —(CH₂)_{p′}S—(CH₂)ₚ—, —C(O)—, —C(O)(CH₂)_{p′}—, —OC(O)—, —NHC(O)—, —O(CH₂)_{p′}—, —C(O)O(CH₂)_{p′}, —OC(O)(CH₂)_{p′}, —OC(O)O(CH₂)_{p′}- and —NHC(O)(CH₂)_{p′}—;
Z is a linker moiety selected from —(CH₂)ₙ—, —(CH₂)_{n′}S—(CH₂)ₙ—, —(CH₂)ₙtriazoleC(O)—, —(CH₂)ₙC(O)—, —O(CH₂)ₙ—, —(CH₂)ₙOC(O)—, and —OC(O)(CH₂)ₙ—;
Z′ is a linker moiety selected from —(CH₂)_{n′}—, —(CH₂)_{n′}S—(CH₂)ₙ—, —C(O)triazole(CH₂)_{n′}—, —C(O)(CH₂)_{n′}—, —C(O)O(CH₂)_{n′}—, —(CH₂)_{n′}C(O)O—;
n and n′ are, independently, an integer from 1 to 6;
p and p′ are, independently, an integer from 1 to 6;
A and A′ are independently selected from C₁₋₂₀alkyl, a trisiloxane, a tetrasiloxane, a pentasiloxane, a hexasiloxane, a heptasiloxane, a functional group that is displaceable by a nucleophile or an electrophile and

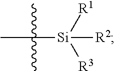

and
R¹, R² and R³ are, independently, selected from C₁₋₂₀alkyl, C₃₋₁₄ cycloalkyl and C₆₋₁₄aryl.

In an embodiment of the present application, Y-A and Y′-A′ are, independently, R⁴C(O) and R^{4′}C(O).

In an embodiment of the application, A and A′ are, independently,

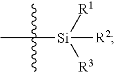

and R¹, R² and R³ are independently selected from C₁₋₁₀-alkyl, C₅₋₆-cycloalkyl and phenyl. In a further embodiment, R¹, R² and R³ are independently selected from C₁₋₆-alkyl, C₅₋₆-cycloalkyl and phenyl. In a further embodiment, R¹, R² and R³ are independently selected from Me, Et, Pr, i-Pr, t-Bu, iPrMe₂C and phenyl. In an embodiment, R¹, R² and R³ may not be a radically polymerizable alkene.

In an embodiment of the present application, A and A′ are independently selected from PhMe₂Si, Ph₂MeSi, EtMe₂Si, Ph₃Si, (n-Bu)Me₂Si, (i-Bu)Me₂Si, (n-Bu)₂MeSi, Et₃Si (TES), (i-Pr)Me₂Si, (cyclohexyl)Me₂Si, (i-Pr)₂MeSi, t-BuMe₂Si (TBS or TBDMS), (i-PrMe₂C)Me₂Si, (i-Pr)₃Si (TIPS), t-BuPh₂Si (TBDPS), (t-Bu)(i-Pr)EtSi, t-Bu₂Si and (cyclohexyl)₃Si. In yet a further embodiment of the present application, A and A′ are independently selected from Et₃Si (TES), (i-Pr)Me₂Si, (cyclohexyl)Me₂Si, (i-Pr)₂MeSi, t-BuMe₂Si (TBS or TBDMS), (i-PrMe₂C)Me₂Si and (i-Pr)₂Si (TIPS). In yet a further embodiment of the present application, A and A′ are independently selected from (i-Pr)₂MeSi and t-BuMe₂Si. In yet a further embodiment of the present application, A and A′ are both (i-Pr)₂MeSi. In yet a further embodiment of the present application, A and A′ are both t-BuMe₂Si.

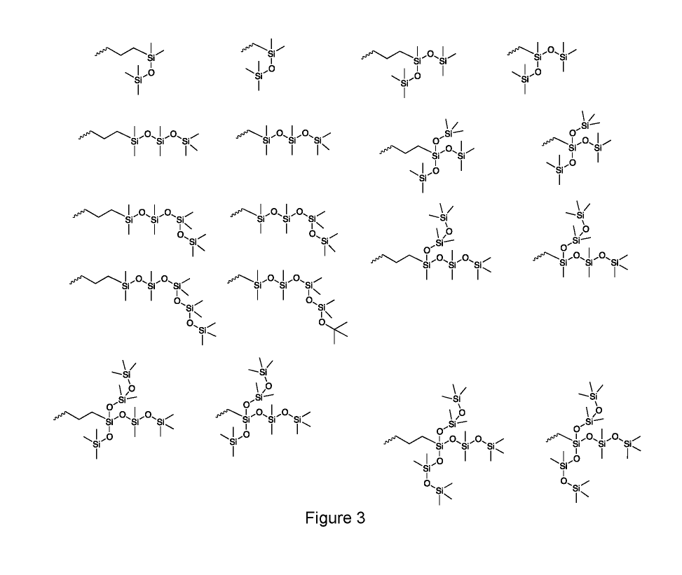

In an embodiment, A and A′, are independently, a siloxane. Non-limiting examples of siloxanes in accordance with the present application are illustrated in FIG. 3. In a further embodiment of the present application, the siloxane is selected from -MeSi(OTMS)₂ and —Si(OTMS)₃.

In an embodiment, the compounds of Formula I have the structure:

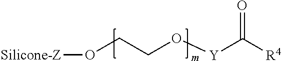

wherein R⁴ is C₁₋₂₀alkyl or an activating group.

In an embodiment, the compounds of Formula II have the structure:

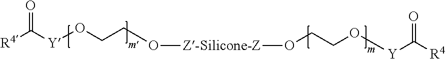

wherein R⁴ and R⁴′ are, independently, C₁₋₂₀alkyl or an activating group. In an embodiment, wherein R⁴ and R⁴′ are, independently, C₈₋₁₈alkyl.

In an embodiment, R⁴ and R⁴′ are, independently, an activating group selected from

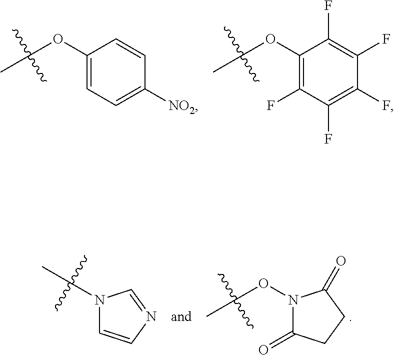 [SMILES: *Oc1ccc([N+](=O)[O-])cc1 ; *Oc1c(F)c(F)c(F)c(F)c1F ; *n1ccnc1 ; *ON1C(=O)CCC1=O]

In the compounds of Formula I and II, A and A′ are, independently, any suitable functional group with complementary reactivity to functional groups on a biological molecule. In an embodiment of the invention A and A′ are, independently, an electrophilic functional group that reacts with nucleophilic functional groups on the biological molecule. A person skilled in the art would appreciate that there are many functional groups that are capable of reacting with nucleophiles, such as amines, alcohols and thiols, in biological molecules to form a covalent linkage between the biological molecule and the polymer. In an embodiment of the invention, A and A′, are, independently, an activating group that is used in peptide synthesis, for example a carbodiimide, an anhydride, an activated ester or an azide. In an embodiment of the application, A and A′, are, independently selected from p-nitrophenyl (i), perfluorophenyl (ii), imidazolyl (iii) or related N-heterocycles and N-hydroxysuccinimidyl (iv) (NHS).

In an embodiment A and A′ are the same.

In an embodiment of the application, p and p′ are independently, 1, 2, 3, or 4. In an embodiment, p and p′ are the same.

In an embodiment of the application, n and n′ are independently, 1, 2, 3, or 4. In an embodiment, n and n′ are the same.

Additional parameters relevant to the compounds of the present application as surfactants to modify the wettability of a silicone elastomer include, for example, the chain length of the PEG polymer component and the chain length of the silicone component. The chain length of both components has a direct impact of the solubility of the copolymers (i.e. surfactants) in various solvents. Non-limiting examples of solvents include THF, methylene chloride and toluene. In an embodiment of the present application, the length of the PEG polymer component ranges from 2 and 20 monomeric units (i.e. m and m′ are, independently, 2 to 20). In a further embodiment of the present application, the length of the PEG polymer component ranges from 5 and 12 monomeric units (i.e. m and m′ are, independently, 5 to 12). In a further embodiment of the present application, the length of the PEG polymer component is 6, 7, 8 or 9 monomeric units (i.e. m and m′ are, independently, 6, 7, 8 or 9). In an embodiment, m and m′ are the same.

The length of the silicone component is typically selected based on its structure (e.g. linear or branched silicone component). In an embodiment of the present application, the silicone is a linear silicone polymer. In a further embodiment of the present application, the linear silicone polymer comprises D (Me₂SiO) monomeric repeat units. In a further embodiment of the present application, the linear silicone polymer comprises from about 10 to 50 D monomeric repeat units. In a further embodiment of the present application, the linear silicone polymer comprises 12, 13, 14, 15, 16, 17 or 18 D monomeric repeat units.

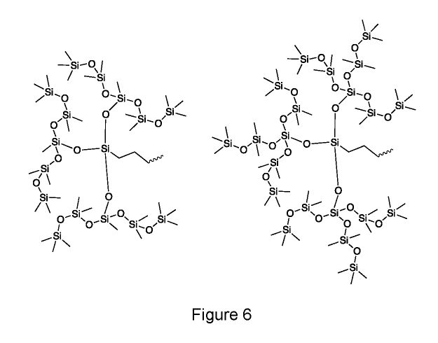

In an embodiment of the present application, the silicone block component is a branched siloxane polymer. In a further embodiment of the present application, the branched siloxane polymer comprises a mixture of at least two of M (Me₃SiO), D (Me₂SiO), T (MeSiO_{3/2}) and Q (SiO_{4/2}) monomeric repeat units. The combination of units is such that proper stoichiometry is followed and there are no free OH groups on the silicone moiety. In a further embodiment of the present application, the total number of M, D, T, Q units comprises from about 10 to 50 monomeric repeat units. In a further embodiment of the present application, the total number of M, D, T, Q units comprises 10 to 24 monomeric repeat units. Non-limiting examples of branched silicone polymers are illustrated in FIG. 6.

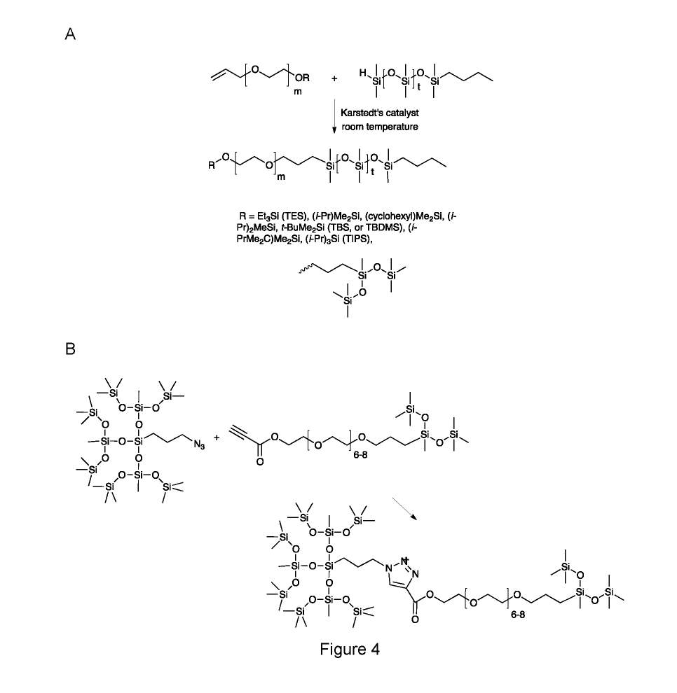

A non-limiting example of a compound of Formula I in accordance with an embodiment of the present application is shown in FIG. 4B.

In an embodiment the compounds of the application are selected from:

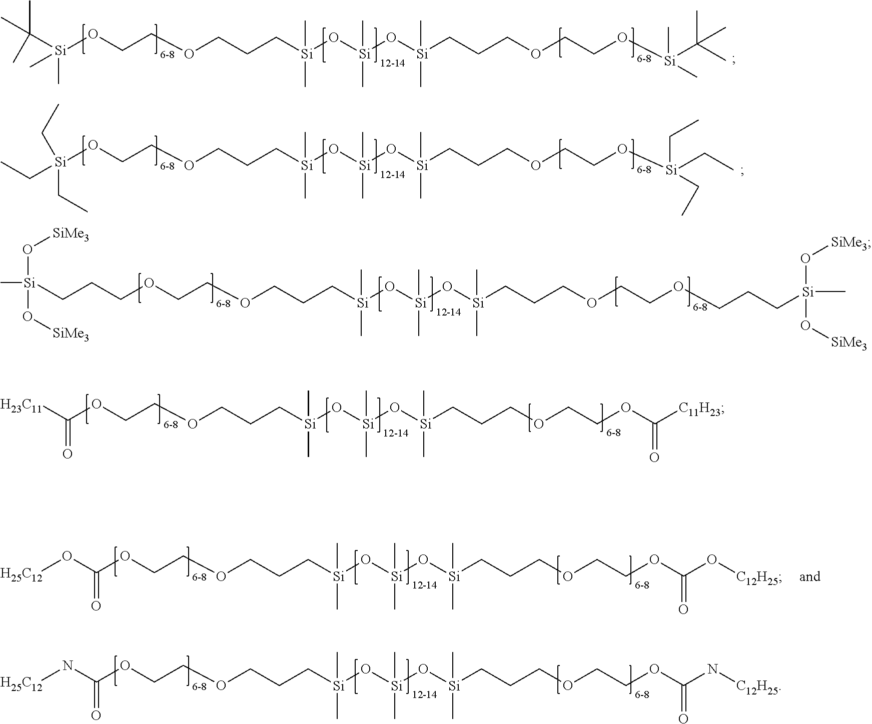

In an embodiment, the compounds of the application are selected from:

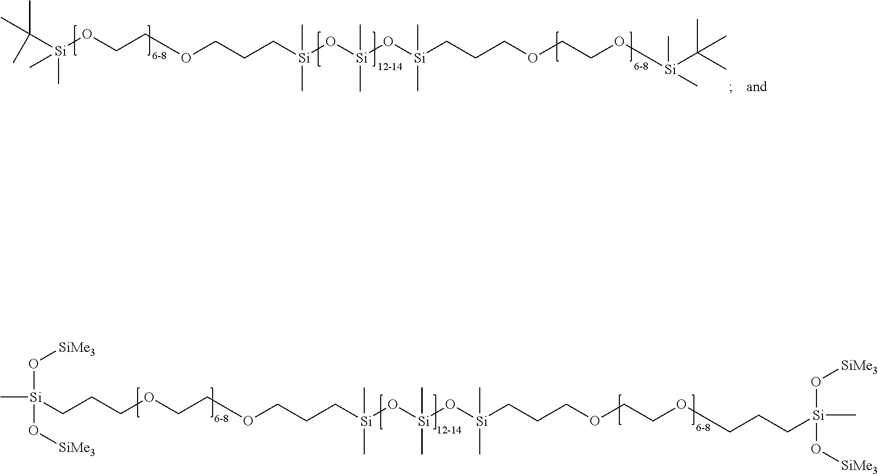

(iii) Methods of Preparation

### (a) Compounds of Formula I

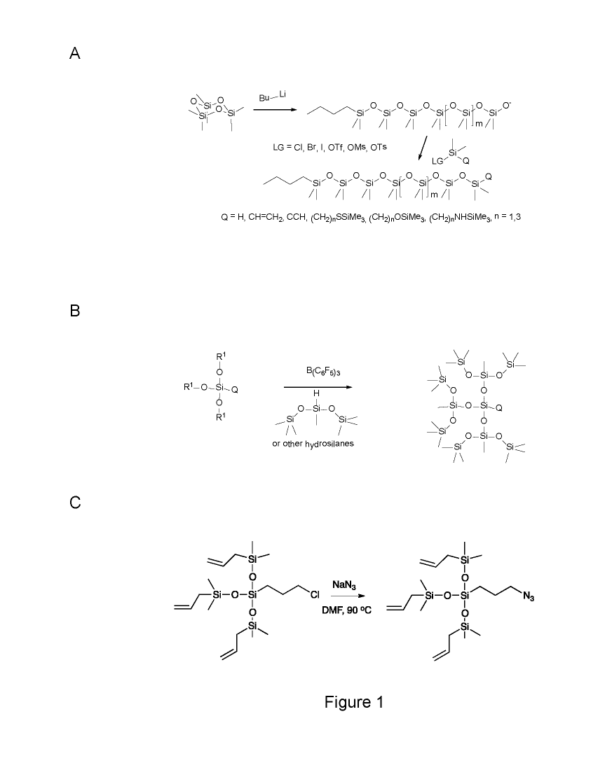

In an embodiment, the present application relates to compounds of Formula I which comprise copolymers of a silicone and PEG. For compounds of Formula I, monofunctional silicone polymers are, in some cases, commercially available. Alternatively, they are synthesized by ring opening polymerization, typically of (Me₂SiO)₃.^{[23]} In an embodiment, the compounds of the application are prepared using monofunctional silicone polymers that are terminated by an SiH group. In further embodiments, the compounds of the application are prepared using monofunctional silicone polymers that are terminated with terminating groups such as CH═CH₂, C≡CH, OH, NH₂ and SH (FIG. 1A). In each case, the monofunctional silicon polymers are prepared using a polymerization reaction that is terminated by the addition of an appropriate silane, non-limiting examples of which include Me₂SiHCl, Me₂(CH═CH₂)SiCl, Me₃SiO(CH₂)₃Me₂SiCl, Me₃SiNH(CH₂)₃Me₂SiCl, and Me₃SiS(CH₂)₃Me₂SiCl, to provide the monofunctional silicon polymers.

Alternative methods for the preparation of monofunctional silicones have been described by Gonzaga et al.,^{[24]} and Keddie et al.^{[25]}. The process involves condensation of hydrosilanes and alkoxysilanes catalyzed by B(C₆F₅)₃. Complex dendritic structures arise from a few reaction steps. A variety of silicones are thus readily available that similarly possess a single functional group, non-limiting examples of which include CH═CH₂, OH, NH₂ and SH. In addition, haloalkyl groups such as chloropropyl and iodopropyl groups, can be introduced as terminal groups (FIG. 1B). These terminal groups, after substitution by azide groups, provide azidoalkyl groups (FIG. 1C). Organic processes such as those described by Clayden et al.,^{[26]} including esterification, amidation, nucleophilic substitution, epoxide ring opening, hydrosilylation, thiol-ene click, copper-based 3+2 cycloaddition click reactions^{[27]} or copper free 3+2 Huisgen cyclization reactions^{[24]} can be used to link the monofunctional silicones to other materials.

The compounds of the application arise from the combination of silicones with hydrophilic species. In an embodiment of the present application, hydrophilic species include poly(ethylene glycol) (PEG). Commercial PEG is typically terminated at both ends of the linear polymer by hydroxyl groups. However, monofunctional PEG terminated by an OH group at one end and by a suitable alkyl group at the other end are also commercially available. Conversion of one or more OH groups on PEG into other functional groups including esters, activated esters, such as NHS or NSC^{[7]} groups, thioesters, amides, tosylates,^{[10]} thiols^{[25]} are well known in the art and are readily performed using standard organic chemical transformations.^{[26]}

In an embodiment, the present application relates to a PEG comprising at one of the two terminal positions a silicone polymer and at the other a group that modifies the surface of a silicone elastomer (A), optionally connected via a linker moiety (Y). In an embodiment of the present application, the group that modifies the surface of a silicone elastomer (A) is a triarylsilane or a trialkylsilane that are well known as protecting groups for alcohols in organic chemistry, as described in Brook.^{[28]}

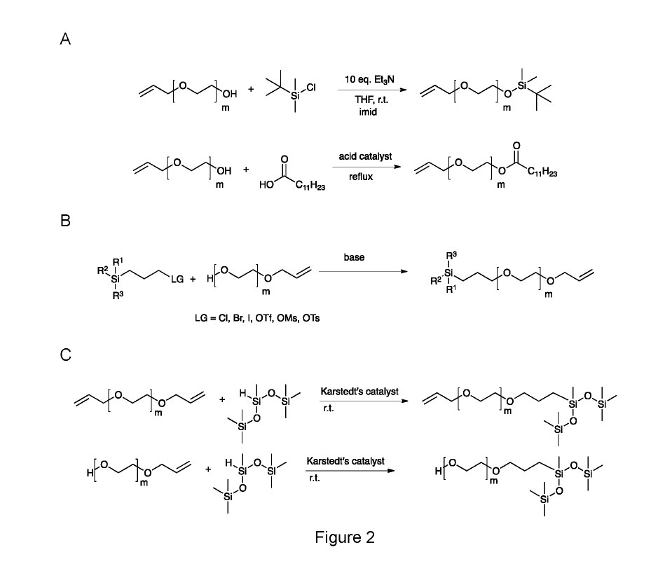

Typical routes to silyl protected alcohols involve basic conditions well within the skill of a person trained in the art. These routes typically comprise the reaction of the alcohol with an appropriate silyl group bearing a leaving group. Non-limiting examples of suitable leaving groups include Cl, Br, I, OTs (OSO₂tolyl), OMs (OSO₂Me), OTf (OSO₂CF₃), OAc, OCOCF₃ and analogues thereof. In an embodiment of the present application, the leaving groups are selected from Cl, OTs, OMs, and OTf (FIG. 2A). Non-limiting examples of routes providing silyl protected alcohols are described by Greene^{[29]} and Kocienski^{[30]}. Analogous routes to ether and ester protected alcohols are well known in the art as shown in the non-limiting formation of a laurate ester from lauroyl chloride (FIG. 2A).

In a further embodiment, the present application relates to PEGs comprising a group that modifies the surface of a silicone elastomer. The group is linked by a carbon spacer to a PEG group (Y-A, wherein Y is —(CH₂)ₚ—). In an embodiment of the present application, the spacer is a 1-carbon spacer. In a further embodiment of the present application, the spacer is a 2-carbon spacer. In a further embodiment of the present application, the spacer is a 3-carbon spacer. In an embodiment, the preparation of such species is accomplished by the Williamson ether synthesis of an alkoxide derived from PEG with a functional silane, including a or y functional haloalkyl groups, where the halogen is, for example, chloro, bromo, iodo (FIG. 2B). In a further embodiment, the preparation of species comprising a 3-carbon spacer is accomplished by hydrosilylation of an allyl-terminated PEG using a hydrosilane-containing siloxane group. In an embodiment, the hydrosilylation is catalyzed by a transition metal catalyst such as Karstedt's platinum catalyst, Wilkinson's rhodium catalyst or other hydrosilylation catalysts known in the art (FIG. 2C).

In an embodiment of the present application, the group that modifies the surface of a silicone elastomer (A) comprises a siloxane. In a further embodiment of the present application, the siloxanes are based on linear or branched tri- to heptasiloxanes. In a further embodiment of the present application, the PEG used in the preparation of the compounds of the application is a monoallyl PEG, commercially available in several different molecular weights. Mono-allyl and di-allyl PEG are also readily available by base-catalyzed Williamson etherification of the corresponding dihydroxy PEG. Hydrosilylation of the mono-allyl or di-allyl PEG using a transition metal catalyst, non-limiting examples of which include Karstedt's platinum catalyst and Wilkinson's rhodium catalyst, yields the desired PEGs with a functional siloxane in high yield (FIG. 2C). In a further embodiment of the present application, the siloxane is linked to the PEG by a carbon spacer.

The PEG modified by a group that modifies the surface of a silicone elastomer, optionally via a linker moiety, is subsequently transformed into a compound of the application in accordance with an embodiment of the present application. Hydrosilylation of allyl-terminated PEGs using hydrosilane-terminated silicones yields the desired compounds. In an embodiment, the hydrosilylation is catalyzed by a transition metal catalyst such as Karstedt's platinum catalyst, Wilkinson's rhodium catalyst or other hydrosilylation catalysts known in the art (FIG. 4A). Otherwise, traditional organic manipulations are used to assemble the compounds of the application. In an embodiment of the present application, the functional groups on the PEG and the silicone are appropriately matched.

### (b) Compounds of Formula II

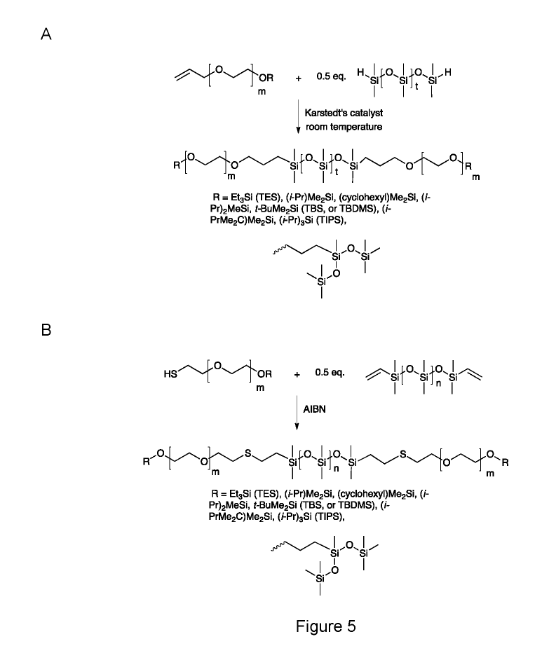

The same structural elements that are used to assemble the compounds of Formula I are used to assemble the compounds of Formula II triblock copolymers with the exception that the central silicone, found in the core of the compounds of Formula II, is difunctional rather than monofunctional, with a reactive group at each terminus to link to the two polymer partners. The PEG-Y-A components are the same as those previously described for the Silicon-PEG-Y-A copolymers, and the reactions used to assemble the compounds of Formula II are also selected from those previously described (FIG. 5).

(iv) Methods of Using the Compounds of the Application

In an embodiment, the compounds of the application are used to surface-modify silicone elastomers by incorporation. Accordingly, the present application includes a process for surface modifying a silicone elastomer, the process comprising:
(a) mixing one or more compounds of Formula (I) and/or (II) as defined herein, either neat or as a dispersion or solution, with a pre-cured silicone elastomer; and
(b) allowing the mixture of pre-cured silicone elastomer and compounds of the Formula (I) and/or (II) to cure.

Prior to curing the silicone elastomer, the compounds of Formula I and/or compounds of Formula II may be mixed neat, or a solution or dispersion with the silicone pre-elastomers in concentrations up to 30 wt %, not including solvents or dispersents. The silicone pre-elastomers are then combined according to standard protocols and allowed to cure. Many types of silicone pre-elastomers are suitable for this modification including those utilizing room temperature vulcanization for cure, platinum-catalyzed hydrosilylation cure^{[31]} and Piers-Rubinsztajn cured polymers.^{[34]}

In an alternate embodiment, the compounds of the application are used to surface-modify silicone elastomers by swelling. Accordingly, the present application also includes a process for surface modifying a silicone elastomer, the process comprising:
(a) soaking a silicone elastomer in a solution or dispersion of one or more compounds of the Formula (I) and/or (II) as defined herein under conditions to produce a swollen elastomer; and
(b) drying the swollen silicone elastomer to produce a surface-modified silicone elastomer.

Surface-modified silicone elastomers are prepared by soaking the elastomer in a solution or dispersion comprising one or more compounds of Formula I and/or compounds of Formula II in which the group A is selected to make the compounds of Formula I and II a surfactant. In an embodiment of the application, surfactant compounds of Formula I and II are those in which A is selected from C₁₋₂₀alkyl,

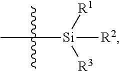

a trisiloxane, a tetrasiloxane, a pentasiloxane, a hexasiloxane and a heptasiloxane, wherein R¹, R² and R³ are, independently, selected from C₁₋₂₀alkyl, C₃₋₁₄cycloalkyl and C₆₋₁₄aryl.

Silicone elastomers are readily available from a variety of manufacturers or can be readily prepared using known methods in the art, non-limiting examples of which include condensation chemistry, platinum-catalyzed hydrosilylation, radical cure or other means as described by Brook.^{[31]} Moreover, suitable solvents for silicone elastomers include THF (tetrahydrofuran), DCM (dichloromethane), toluene, or related aprotic organic solvents, or low molecular weight silicone oils, like (Me₂SiO)₄ and (Me₂SiO)₅, or mixtures thereof. The selection of a solvent or solvent system would be well within the skill of a person trained in the art.

In an embodiment, silicone elastomer surfaces are modified by swelling a silicone elastomer in a solution or dispersion comprising one or more surfactants compound of Formula I and/or II. In an embodiment of the present application, the silicone elastomer is swelled in a THF solution comprising one or more surfactant compounds of Formula II. In an embodiment of the present application, the silicone elastomer is swollen in a THF solution comprising one or more surfactant compounds of Formula I. In a further embodiment of the present application, the concentration of the one or more surfactant compounds of Formula I and/or II ranges from about 1 to about 20% (w/v). In a further embodiment of the present application, the concentration of the one or more surfactant compounds of Formula I and/or II ranges from about 5 to about 20% (w/v). In a further embodiment of the present application, the concentration of the one or more surfactant compounds of Formula I and/or II ranges from about 10 to about 20% (w/v). In a further embodiment of the present application, the concentration of the one or more surfactant compounds of Formula I and/or II ranges from about 15 to about 20% (w/v). In non-limiting embodiments, for example, the concentration of the one or more surfactant compounds of Formula I and/or II is 1% (w/v), 2% (w/v), 3% (w/v), 4% (w/v), 5% (w/v), 6% (w/v), 7% (w/v), 8% (w/v), 9% (w/v), 10% (w/v), 11% (w/v), 12% (w/v), 13% (w/v), 14% (w/v), 15% (w/v), 16% (w/v), 17% (w/v), 18% (w/v), 19% (w/v) 20% (w/v), or any range or integer derivable therein. In an embodiment, the swelling process is allowed to proceed over a period of time ranging from about 1 to about 20 hours. In non-limiting embodiments, for example, the swelling is performed, for example, for at least 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hour or 20 hours or any range or integer derivable therein.

After swelling, it is an embodiment that the elastomers are subsequently removed from the solution or dispersion, allowed to dry until the elastomer returns (approximately) to its original size, rinsed with fresh solvent, and again allowed to dry. In an embodiment, the elastomers are then washed thoroughly with distilled water and dried under a stream of nitrogen.

Additional parameters relevant to the compounds of the present application as surfactants to modify the wettability of a silicone elastomer include, for example, the chain length of the PEG polymer component and the chain length of the silicone component. The chain length of both components has a direct impact of the solubility of the copolymers (i.e. surfactants) in various solvents. Non-limiting examples of solvents include THF and water. In an embodiment of the present application, the length of the PEG polymer component ranges from between 2 and 20 monomeric units. In a further embodiment of the present application, the length of the PEG polymer component ranges from between 5 and 12 monomeric units. In a further embodiment of the present application, the length of the PEG polymer component is 6, 7, 8 or 9 monomeric units.

In an embodiment of the present application, the silicone component is a linear silicone polymer. In a further embodiment of the present application, the linear silicone polymer comprises D (Me₂SiO) monomeric repeat units. In a further embodiment of the present application, the linear silicone polymer comprises from about 10 to 50 D monomeric repeat units. In a further embodiment of the present application, the linear silicone polymer comprises 12, 13, 14, 15, 16, 17 or 18 D monomeric repeat units.

In an embodiment of the present application, the silicone component is a branched siloxane polymer. In a further embodiment of the present application, the branched siloxane polymer comprises a mixture of at least two of M (Me₃SiO), D (Me₂SiO), T (MeSiO_{3/2}) and Q (SiO_{4/2}) monomeric repeat units. The combination of units is such that proper stoichiometry is followed and there are no free OH groups on the silicone moiety. In a further embodiment of the present application, the total number of M, D, T, Q units comprises from about 10 to 50 monomeric repeat units. In a further embodiment of the present application, the total number of M, D, T, Q units comprises 10, 11, 12, 13, 14, 15, 16, 17, 18, 19, 20, 21, 22, 23 or 24 monomeric repeat units. Non-limiting examples of branched silicone polymers are illustrated in FIG. 6.

Unmodified PDMS elastomer surfaces show high sessile drop water contact angles, typically in excess of 105°. When the surface active compounds of the present application were incorporated into the elastomer prior to cure, the resulting elastomer surfaces exhibited significantly lower water contact angles. In one embodiment, when 5 wt % of (tBS-PEG₆₋₈-(Me₂SiO)₁₂₋₁₄-PEG₆₋₈-tBS or Laurate-PEG₆₋₈-(Me₂SiO)₁₂₋₁₄-PEG₆₋₈-Laurate) was incorporated into the platinum-cure silicone elastomer Sylgard 184 (Dow Corning) the resulting elastomer exhibited a water contract angle of 57 and 62°, respectively. When 5 wt % of (tBS-PEG₆₋₈-(Me₂SiO)₁₂₋₁₄-PEG₆₋₈-tBS or Laurate-PEG₆₋₈-(Me₂SiO)₁₂₋₁₄-PEG₆₋₈-Laurate was incorporated into the dibutyltin dilaurate-(DBTL) cured silicone elastomer silanol terminated PDMS (2000 cst. Gelest,) and tetraethyl orthosilicate, the resulting elastomer exhibited a water contract angle of 8 and 10°, respectively.

When the elastomer surfaces were treated with the surfactant compounds of the present application, the water contact angles dropped significantly. In an exemplary embodiment of the present application, treatment of a PDMS elastomer surface with (M₂T(CH₂)₃-PEG₆₋₈-(Me₂SiO)₁₂₋₁₄-PEG₆₋₈-(CH₂)₃TM₂ or tBS-PEG₆₋₈-(Me₂SiO)₁₂₋₁₄-PEG₆₋₈-tBS) resulted in the water contact angles dropping significantly to 6 and 18°, respectively. When the PDMS elastomer surface was treated with the analogous surfactant PEG compounds bearing a hydroxyl group instead of an “A” group (i.e., HO-PEG₆₋₈-(Me₂SiO)₁₂₋₁₄-PEG₆₋₈-OH) the contact angles dropped to only 78° compared to the unmodified elastomer. In an embodiment, the observed contact angles of the modified elastomer surfaces are depended on the concentration of the surfactant compound solution. Accordingly, the method further comprises controlling the degree of surface wettability by varying the concentration of the surfactant compound solution.

### (b) Preparation of Biomolecule Compatible Silicone Elastomers

The immobilization of amino acids, peptides, proteins, sugars, polysaccharides; nucleosides, nucleotides (RNA, DNA), etc., and modified versions thereof, is a commonly exploited strategy to change the chemistry of a surface. The modified surfaces may then be used for biodiagnostic, biosensor, bioaffinity, and related applications. They may also be used to change the nature of subsequent deposition of biomolecules so that in vivo applications such as antithrombogenic coatings on stents, shunts and catheters or nonfouling contact lens surfaces can be achieved. Less complex, but equally important applications include non-fouling surfaces on membranes or in vessels used for fermentation. Silicones are also extremely useful as coating materials (conformal coatings are easy to prepare from silicones).

Biomaterials destined for implantation generally should not be recognized as a foreign body. If they are recognized as foreign at all, the interactions with the body must be extremely weak. One of the first events that takes place after implantation is the adsorption of proteins on the substrate surface, which initiates a cascade of biological events, generally to the detriment of the biomaterial. Minimizing this behaviour, and particularly any subsequent changes in protein structure (denaturing) after deposition is one of the main challenges which remain in bioimplantable materials. Silicone materials modified with PEO are demonstrably excellent at repelling a series of proteins. By contrast, the silicone materials of the present invention are readily surface-modified with amino acids, peptides, proteins or carbohydrates. These tethered biomolecules retain their bioactivity and further interact with other biomolecules in the environment. Thus, the surfaces of the present invention will be useful for in vivo implantation and for liners exposed to biological broths (e.g., fermentation, drug delivery systems, etc.). In addition to implantation, there will be other applications in coatings.

In one embodiment, compounds of the application that possess reactive organic functional groups that react with nucleophiles are used to treat the surfaces of silicone elastomers. Following treatment, as described above, the water contact angles were lower than those of pure silicone elastomers. When exposed to solutions containing nucleophiles, including amines and/or alcohols, for example on biological molecules such as proteins or saccharides, a reaction occurred that tethered said nucleophiles to the silicone surface. A person skilled in the art would appreciate that the reactive organic functional groups can also include those that react with other types of complementary species to form covalent, or other types of bonds, including for example, reactive organic functional groups that react with electrophiles are used to treat the surfaces of silicone elastomers to make them susceptible to reactions with suitable electrophiles, such as carboxylic acids, acid chlorides and/or active esters.

### EXPERIMENTAL

A number of examples are provided herein below illustrating the preparation and use of various copolymers (i.e. surfactants). The following non-limiting examples are illustrative of the present application.

Materials

Hydride terminated PDMS (PDMS-H (7-10 cst.)) and bis(trimethylsiloxy)methylsilane were purchased from Gelest; tort-butyldimethylsilyl chloride, chlorotriethylsilane, Karstedt's catalyst, and triethylamine were purchased from Aldrich. The mono-allyl ether of poly(ethylene glycol) (allylPEG) was obtained from Clariant in three different molecular weights: 400, 550 and 1100. A Sylgard 184 silicone elastomer kit was purchased from Dow Corning. The solvents used were dried using an activated alumina column under a nitrogen stream before use. α,ω-Bis-allyl-PEG was synthesized as previously described.^{[7]}

Instrumentation/Characterization

¹H and ¹³C NMR spectra were recorded at room temperature on a Bruker AV-200 (at 200.13 MHz for protons, at 50.3 MHz for carbon, respectively).

Static contact angles were measured on flat PDMS or modified PDMS films using a Ramé Hart NRL C.A. goniometer. Milli-Q water (18 MΩ/cm) was used with a drop volume of approximately 20 μL. The measurement of water contact angles as a function of time was performed in a sealed container that was saturated with water vapor at 25° C.

Synthesis of HO-PEG-PDMS-PEG-OH

To a mixture of poly(ethylene glycol) monoallyl ether (3.88 g, 0.01 mol) and hydride-terminated PDMS (7-10 cst., MW 1090, 5.45 g, 0.005 mol) was added Karstedt's catalyst (20 μL, Pt, ˜2% in xylene, 0.002 mmol Pt). The resulting mixture was subsequently stirred at room temperature for 5 h. After reaction, the residue of Karstedt's catalyst was removed by filtration through activated carbon and the volatiles were removed in vacuo giving HO-PEG-PDMS-PEG-OH as colorless oil. ¹H NMR (δ, 200.13 MHz, CDCl₃): 0.06 (m, 52H), 0.52 (m, 4H), 1.59 (m, 4H), 3.40 (m, 4H), 3.64 (m, 60H) ppm. ¹³C NMR (δ, 50.3 MHz, CDCl₃): −5.25, 18.36, 25.9, 62.7, 69.4-70.7 (C of EO repeat units), 72.2, 72.6, 117.1, 134.7 ppm.

Synthesis of tBS-PEG-allyl-PEG-tBS

To a mixture of polyethylene glycol monoallyl ether (4.0 g, 10.3 mmol) and triethylamine (10.4 g, 103.1 mol) in dry THF (mL) was slowly added t-butyldimethylsilyl chloride (1.86 g, 12.4 mmol) in dry THF (100 mL). The reaction mixture was subsequently stirred overnight while at room temperature. The solvent and excess triethylamine were then removed under reduced pressure, the residue resuspended in diethyl ether and the precipitate filtered off. Removal of ether gave the crude product as a yellow oil. The product was purified by dissolving the crude product in CH₃CN (150 mL), washing with hexane (3×30 mL) and drying in vacuo. A colorless oil (5.1 g, 10.1 mmol, 98% yield) was obtained. ¹H NMR (δ, 200.13 MHz, CDCl₃): 0.04 (s, 6H), 0.87 (s, 9H), 3.71 (m, 32H), 4.00 (d, 2H, J=5.6 Hz), 5.20 (dd, 2H, J=1.4, 5.6, Hz), 5.89 (m, 2H) ppm. ¹³C NMR (δ, 50.3 MHz, CDCl₃): −5.25, 18.4, 25.9 (3C), 62.7, 69.4-70.7 (Cs of EO repeats), 72.2, 72.6, 117.1, 134.7 ppm.

Synthesis of tBS-PEG-PDMS-PEG-tBS

To a mixture of allyl, t-butyldimethylsiloxy-PEG (3.5 g, 7.0 mmol) and hydride-terminated PDMS (7-10 cst., MW 1090, 3.8 g, 3.5 mol) was added Karstedt's catalyst (20 μL, ˜2% Pt in xylene, 0.002 mmol Pt). The resulting mixture was subsequently stirred at room temperature for 5 h. After reaction, the residue of Karstedt's catalyst was removed by filtration through activated carbon and volatiles were removed in vacuo giving tBS-PEG-PDMS-PEG-tBS as a colorless oil. ¹H NMR (δ, 200.13 MHz, CDCl₃): 0.07 (m, 102H), 0.55 (m, 4H), 0.89 (s, 18H), 1.56 (m, 4H), 3.41 (t, 4H, J=7.00 Hz), 3.55 (m, 58H), 3.761 (dd, J=5.6, 1.4 Hz) ppm. ¹³C NMR (δ, 50.3 MHz, CDCl₃): −5.45, −0.08, 0.84-0.97 (C of repeat Me₂SiO), 13.9, 18.1, 23.2, 25.7 (3C), 62.5, 69.8-70.6 (Cs of EO repeats), 72.5, 73.9 ppm.

Synthesis of M₂T(CH₂)₃-PEG-allyl

To a solution of α,ω-bis-allyl-PEG (4.74 g, 10 mmol) and bis(trimethylsiloxy)methylsilane (2.22 g, 10 mmol) in toluene (50 mL) was added Karstedt's catalyst (5 μL, ˜2% Pt in xylene, 0.0005 mmol Pt). The resulting mixture was subsequently stirred at room temperature for 5 h. After reaction, the residue of Karstedt's catalyst was removed by filtration through activated carbon and volatiles were removed in vacuo. The product was purified by dissolving the crude product in water (150 mL) followed by washing with hexane (3×30 mL), and extraction with CH₂Cl₂ (5×30 mL). The combined extracts were dried over anhydrous Na₂SO₄ and filtered, dried in vacuo, giving M₂T(CH₂)₃-PEG-allyl as colorless oil (4.76 g, 6.8 mmol, 68% yield). ¹H NMR (δ, 200.13 MHz, CDCl₃): −0.02 (s, 3H), 0.06 (m, 18H), 0.42 (m, 2H), 1.55 (m, 2H), 3.38 (m, 2H), 3.62 (m, 42H), 4.01 (d, 2H, J=5.6 Hz), 5.20 (dd, J=5.6, 1.4 Hz, 2H), 5.86 (m, 1H) ppm. ¹³C NMR (δ, 50.3 MHz, CDCl₃): −0.56, 1.67, 13.3, 23.0, 69.2, 69.6-70.3 (C of repeat EO), 71.9, 73.8, 116.7, 134.6 ppm.

Synthesis of M₂T(CH₂)₃-PEG-PDMS-PEG-(CH₂)₃TM₂

To a mixture of bis-allyl-PEG (3.0 g, 4.3 mmol) and hydride-terminated PDMS (7-10 cst., MW 1090, 2.35 g, 2.1 mmol) was added Karstedt's catalyst (10 μL, ˜2% Pt in xylene, 0.001 mmol Pt). The resulting mixture was subsequently stirred at room temperature for 5 h After reaction, the residue of Karstedt's catalyst was removed by filtration through activated carbon and the volatiles were removed in vacuo giving M₂T(CH₂)₃-PEG-PDMS-PEG-(CH₂)₃TM₂ as colorless oil. ¹H NMR (δ, 200.13 MHz, CDCl₃): 0.08 (m, 132H), 0.47 (m, 8H), 1.57 (m, 8H), 3.42 (t, 8H, J=7.2 Hz), 3.64 (m, 80H).

Synthesis of Allyl-PEG-Laurate

A mixture of polyethylene glycol monoallyl ether (4.0 g, 10.3 mmol), lauric acid (2.06 g, 10.3 mmol) and p-toluenesulfonic acid (0.010 g, 0.06 mmol) in toluene was refluxed at 110-115° C. using a Dean-Stark trap for continuous removal of water over a period of 5 hours. After reaction, the mixture was washed with saturated sodium bicarbonate, water (2×) and saline, respectively. The organic phase was collected and dried over sodium sulfate, filtered and the solvent removed in vacuo to give allyl-PEG-laurate as colorless oil. Yield: 5.02 g (83%). ¹H NMR (δ, 200.13 MHz, CDCl₃): 0.85 (t, 3H, J=6.0 Hz), 1.23 (m, 6H), 1.59 (m, 2H), 2.30 (m, 2H), 3.66 (m, 30H), 4.01 (d, 2H, J=5.6 Hz), 4.18 (m, 2H), 5.18 (dd, J=5.6, 1.4 Hz, 2H), 5.89 (m, 1H) ppm. ¹³C NMR (δ, 50.3 MHz, CDCl₃): 14.0, 22.5, 24.7, 29.0, 29.1, 29.2, 29.3, 29.4, 31.7, 34.0, 63.2, 69.4-70.7 (C of repeat EO), 72.0, 72.3, 116.8, 134.6, 173.5 ppm.

Synthesis of Laurate-PEG-PDMS-PEG-Laurate

To a mixture of allyl-PEG-laurate (4.0 g, 7.0 mmol) and hydride terminated PDMS (7-10 cst., MW 1090, 3.8 g, 3.5 mol) was added 20 μL of Karstedt's catalyst. The resulting mixture was subsequently stirred at room temperature for 5 h. After reaction, the residue of Karstedt's catalyst was removed by filtration through activated carbon and the volatiles were removed in vacuo giving Laurate-PEG-PDMS-PEG-Laurate as colorless oil. ¹H NMR (δ, 200.13 MHz, CDCl₃): 0.080 (m, 90H), 0.52 (m, 2H), 0.87 (s, 8H), 1.25 (m, 32H), 1.61 (m, 8H), 2.30 (m, 4H), 3.41 (m, 4H), 3.55 (m, 60H), 4.20 (m, 4H) ppm. ¹³C NMR (δ, 50.3 MHz, CDCl₃): 0.01, 0.84-0.97 (C of repeat Me₂SiO), 13.97, 14.02, 22.5, 24.8, 29.0, 29.18, 29.2, 29.3, 29.5, 31.8, 34.1, 63.2, 69.1, 69.8-70.6 (C of repeat EO), 72.4, 74.1, 173.7 ppm.

Surface Modification of Silicone Elastomers by Swelling

Sylgard 184 prepolymer base was mixed thoroughly with its curing agent (10:1, w/w) and degassed under vacuum. The PDMS films were cured at 50° C. for 10 h. After full curing, the films were punched into small pieces of ca. 6 mm diameter×0.5 mm thickness. The PDMS pieces were Soxhlet extracted with CH₂Cl₂ to remove any residual uncrosslinked components and dried under vacuum before surface modification.

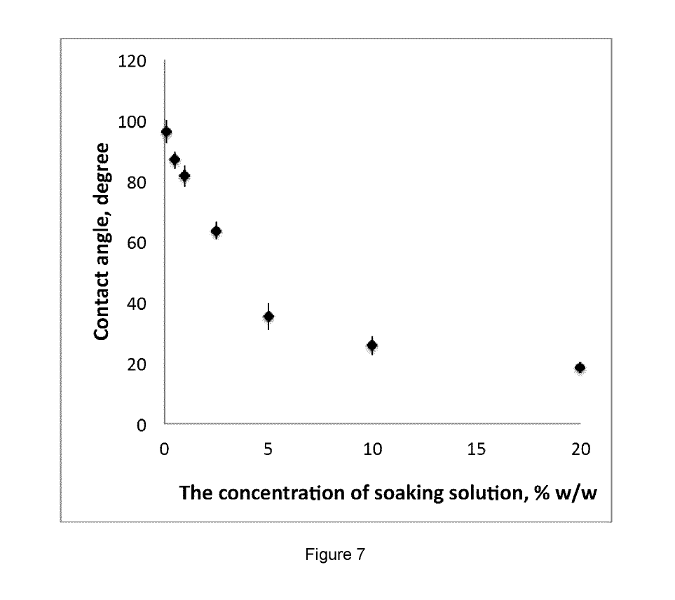

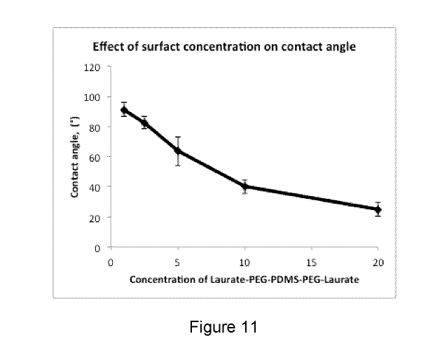

The general procedure for surface modification by swelling-de-swelling is as follows: the PDMS pieces were soaked in a THF solution of a compound of the application (concentration range 1-20% (w/w)) for 20 h, then removed from the solution and dried until the elastomer returns (approximately) to its original size. The pieces were then thoroughly washed with DI water and dried under a stream of nitrogen. For wettability studies, the static contact angle was recorded 3 minutes after the water drop has settled. Results using varying concentrations of tBS-PEG₆₋₈-(Me₂SiO)₁₂₋₁₄-PEG₆₋₈-tBS are shown in FIG. 7 and using varying concentrations of Laurate-PEG-PDMS-PEG-Laurate are shown in FIG. 11.

The observed contact angles of the modified elastomer surfaces were found to be directly depended on the concentration of the surfactant compound solution. The correlation between surfactant compound concentration and contact angle is illustrated by FIGS. 7 and 11. As can be observed from FIG. 7, once surfactant compound concentrations reached about 10% (w/w), further increases in concentration had little impact on the observed contact angles. However, there appears to be a substantially linear correlation between observed contact angles and surfactant compound concentrations below 10% (w/w). Some control over the degree of surface wettability is thus possible simply by varying the concentration of the surfactant solution.

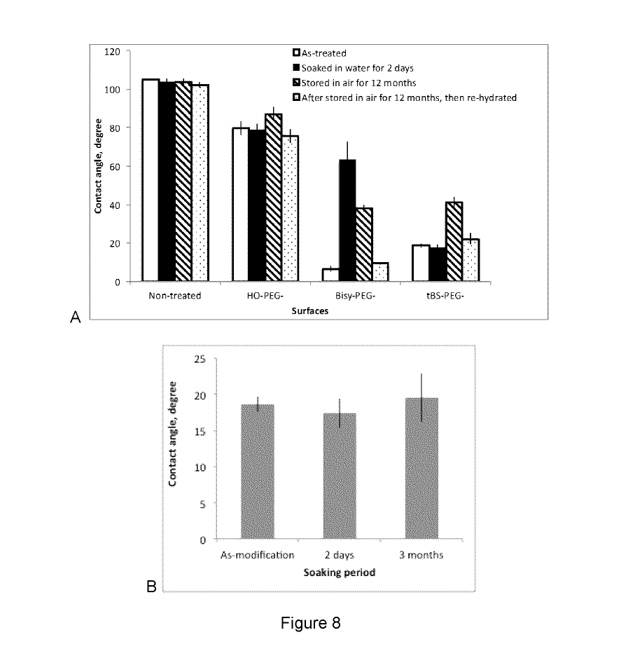

The stability of the modified elastomer surfaces is depended on the surfactant compound used to modify the surface. M₂T(CH₂)₃-PEG₆₋₈-(Me₂SiO)₁₂₋₁₄-PEG₆₋₈-(CH₂)₃TM₂ surfactant-modified surfaces exhibited an increased contact angle to 70° following soaking in water for 2 days. This is likely due to hydrolytic cleavage of the bis(trimethylsiloxy)methylsilyl end group: this group is known to be very susceptible to hydrolysis (FIG. 8A).^{[32]} Surfaces modified with tBS-PEG₆₋₈-(Me₂SiO)₁₂₋₁₄-PEG₆₋₈-tBS, by contrast, maintained their wettability even after soaking in water for 2 days. In order to confirm that the PDMS block is held firmly on the surface of a PDMS substrate, the treated surfaces were soaked in water for 3 months. During this period, the soaking water was replaced 6 times with fresh water. The subsequently obtained results illustrate that the contact angles had not changed significantly (FIG. 8B) indicating essentially no change in surface wettability over time.

In long-term stability tests, PDMS surfaces modified with either tBS-PEG₆₋₈-(Me₂SiO)₁₂₋₁₄-PEG₆₋₈-tBS or M₂T(CH₂)₃-PEG₆₋₈-(Me₂SiO)₁₂₋₁₄-PEG₆₋₈-(CH₂)₃TM₂ showed increases of contact angle following storage in air for 12 months (41° and 38° respectively). However, after re-hydrating the surfaces by soaking them in water over a period of 1 hour, followed by drying in a nitrogen stream, the contact angles dropped again to 25° and 9°, respectively. These values closely resemble those observed after the initial surface modification.

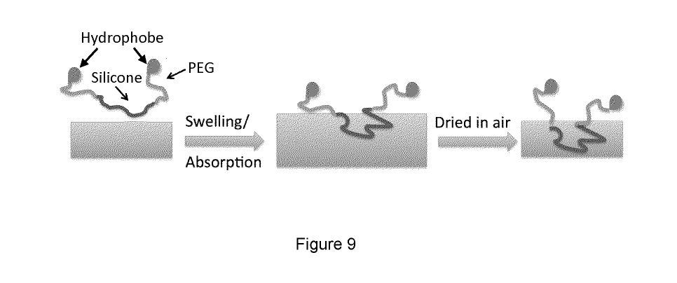

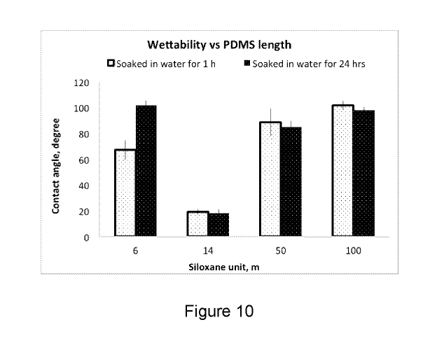

The surface modification of a silicone elastomer by a surfactant compound of the present application involves a swelling step in a suitable organic solvent such as THF.^{[33]} The selection of a solvent or solvent system would be well within the skill of a person trained in the art. In an embodiment, the efficacy of the compounds of the application at wetting silicone elastomer surfaces depends, in addition to the nature of the A groups, the lengths of the PEG and silicone. Without wishing to be bound by theory, the swelling step permits the silicone of the compounds of the application to enter the silicone elastomer, and then be trapped after removal of the solvent (FIG. 9). The length of the silicone plays a role in establishing effective anchoring of the surfactant into the silicone elastomer (FIG. 10). With short block lengths (<10 M, D, T, Q units), the compound of the application is readily washed off after soaking in water. In contrast, very long linear blocks, for example, in excess of 50 units, or large, branched silicone blocks are unable to effectively penetrate the elastomer and similarly do not remain anchored over extensive periods of time in water.

The wetting behavior noted for an elastomer modified by a compound of the present application is still observed in cases where the PEG blocks are short (<6 monomer units)- or long (>14). Without wishing to be bound by theory, insufficient hydrophilic PEG groups are present to wet out water with short chains. However, when the PEG chains are too long, the chain can loop to the surface, exposing a PEG chain, but the A group is not liberated from the surface to act as a modifier of the surface properties. Intermediate chain lengths provide an optimal mobile surfactant anchored at the elastomer surface, but which can migrate to the air/water droplet interface reducing the surface tension.

Surface Modification of Silicone Elastomers by Incorporation

The general procedure for surface modification of silicone elastomers by incorporation is as follows:

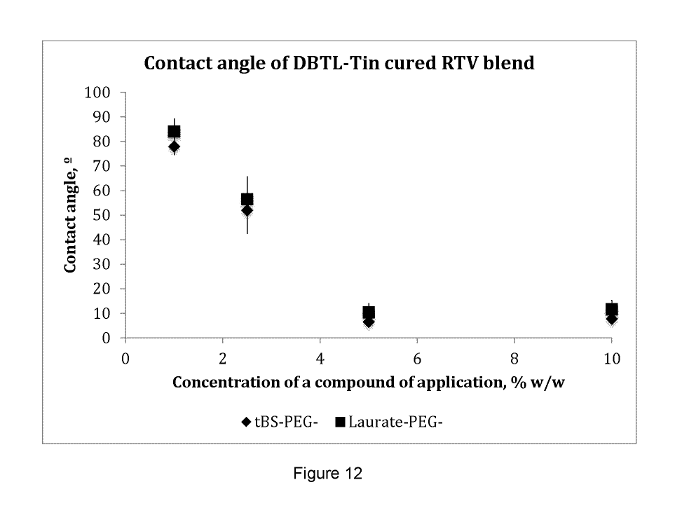

RTV (room temperature vulcanization)-cured PDMS blend: to a mixture of silanol-terminated polydimethylsiloxane, PDMS, (2000 cSt., 1 g, containing 0.056 mmol silanol group) and tetraethyl orthosilicate (0.023 g, 0.11 mmol) was added a compound of the application (Laurate-PEG-PDMS-PEG-Laurate or tBS-PEG-PDMS-PEG-tBS, concentration range 1-10% w/w), dibutyltin dilaurate (0.005 g) was added, the mixture was mixed thoroughly and degassed under vacuum. The PDMS films were cured at room temperature for 24 h. For wettability studies, the static contact angle was recorded 3 minutes after the water drop was placed on the surface. Results are shown in FIG. 12.

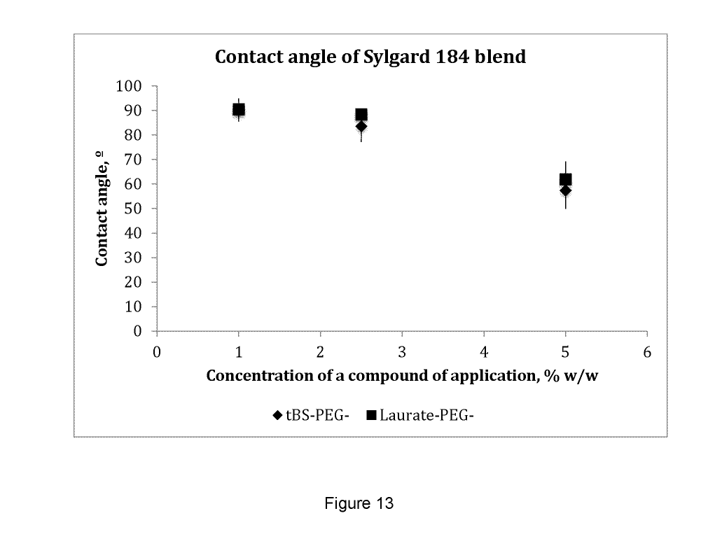

Sylgard 184 PDMS blend (platinum cured hydrosilylation): Sylgard 184 pre-polymer base was mixed thoroughly with its curing agent (10:1, w/w) and a compound of application ((Laurate-PEG-PDMS-PEG-Laurate or tBS-PEG-PDMS-PEG-tBS, concentration range 1-10% w/w). The PDMS films were cured at 50° C. for 10 h. With these polymers, when the concentration of a compound of application is greater than or equal to 10% (wfw), the PDMS film does not fully cure. For wettability studies, the static contact angle was recorded 3 minutes after the water drop has settled. Results are shown in FIG. 13.

All publications, patents and patent applications are herein incorporated by reference in their entirety to the same extent as if each individual publication, patent or patent application was specifically and individually indicated to be incorporated by reference in its entirety.

### FULL CITATIONS FOR DOCUMENTS REFERRED TO IN THE APPLICATION

1. (a) He, Q. G.; Liu, Z. C.; Xiao, P. F.; Liang, R. Q.; He, N. Y.; Lu, Z. H., Preparation of hydrophilic poly(dimethylsiloxane) stamps by plasma-induced grafting. Langmuir 2003, 19 (17), 6982-6986; (b) Bae, W. S.; Convertine, A. J.; McCormick, C. L.; Urban, M. W., Effect of sequential layer-by-layer surface modifications on the surface energy of plasma-modified poly(dimethylsiloxane). Langmuir 2007, 23 (2), 667-672; (c) Makamba, H.; Kim, J. H.; Lim, K.; Park, N.; Hahn, J. H., Surface modification of poly(dimethylsiloxane) microchannels. Electrophoresis 2003, 24 (21), 3607-3619.
2. (a) Berdichevsky, Y.; Khandurina, J.; Guttman, A.; Lo, Y. H., UV/ozone modification of poly(dimethylsiloxane) microfluidic channels. Sens. Actuator B-Chem. 2004, 97 (2-3), 402-408; (b) Hu, S. W.; Ren, X. Q.; Bachman, M.; Sims, C. E.; Li, G. P.; Allbritton, N., Surface modification of poly(dimethylsiloxane) microfluidic devices by ultraviolet polymer grafting. Anal. Chem. 2002, 74 (16), 4117-4123; (c) Efimenko, K.; Wallace, W. E.; Genzer, J., Surface modification of Sylgard-184 poly(dimethyl siloxane) networks by ultraviolet and ultraviolet/ozone treatment. J. Colloid Interface Sci. 2002, 254 (2), 306-315.
3. Di Virgilio, V.; Bermejo, S.; Castaner, L., Wettability Increase by “Corona” Ionization. Langmuir 2011, 27 (15), 9614-9620.
4. Sui, G. D.; Wang, J. Y.; Lee, C. C.; Lu, W. X.; Lee, S. P.; Leyton, J. V.; Wu, A. M.; Tseng, H. R., Solution-phase surface modification in intact poly(dimethylsiloxane) microfluidic channels. Anal. Chem. 2006, 78 (15), 5543-5551.
5. Hoek, I.; Tho, F.; Arnold, W. M., Sodium hydroxide treatment of PDMS based microfluidic devices. Lab on a Chip 2010, 10 (17), 2283-2285.
6. Brook, M. A.; Zhao, S.; Liu, L.; Chen, Y., Surface etching of silicone elastomers by depolymerization. Can. J. Chem. 2011, 90 (1), 153-160.
7. Chen, H.; Brook, M. A.; Sheardown, H. D.; Chen, Y.; Klenkler, B., Generic bioaffinity silicone surfaces. Bioconjugate Chem. 2006, 17 (1), 21-28; and Brook, M. A., Sheardown S. and Chen, H. PCT Patent Application Publication no. WO 2005/111116, Nov. 24, 2005.
8. Hui, A. Y. N.; Wang, G.; Lin, B. C.; Chan, W. T., Microwave plasma treatment of polymer surface for irreversible sealing of microfluidic devices. Lab on a Chip 2005, 5 (10), 1173-1177.
9. Chen, H.; Wang, L.; Zhang, Y.; Li, D.; McClung, W. G.; Brook, M. A.; Sheardown, H.; Brash, J. L., Fibrinolytic Poly(dimethyl siloxane) Surfaces. Macromol. Biosci. 2008, 8 (9), 863-870.
10. Alauzun, J. G.; Fortuna, J. N.; Sheardown, H.; Gonzaga, F.; Brook, M. A., Generic, S(N)2 reactive silicone surfaces protected by poly(ethylene glycol) linkers: facile routes to new materials. J. Mater. Chem. 2009, 19 (28), 5033-5038.
11. Rambarran, T.; Gonzaga, F.; Brook, M. A., Multifunctional amphiphilic siloxane architectures using sequential, metal-free click ligations. J. Polym. Sci. A: Polym. Chem. 2013, 51 (4), 855-864.
12. (a) Zhang, Z.; Wang, J.; Tu, Q.; Nie, N.; Sha, J.; Liu, W.; Liu, R.; Zhang, Y.; Wang, J., Surface modification of PDMS by surface-initiated atom transfer radical polymerization of water-soluble dendronized PEG methacrylate. Colloid Surf. B-Biointerfaces 2011, 88 (1), 85-92; (b) Xiao, D.; Zhang, H.; Wirth, M., Chemical Modification of the Surface of Poly(dimethylsiloxane) by Atom-Transfer Radical Polymerization of Acrylamide. Langmuir 2002, 18 (25), 9971-9976.
13. Chaudhury, M. K.; Whitesides, G. M., Direct measurement of interfacial interactions between semispherical lenses and flat sheets of poly(dimethylsiloxane) and their chemical derivatives. Langmuir 1991, 7 (5), 1013-1025.
14. (a) Morra, M.; Occhiello, E.; Marola, R.; Garbassi, F.; Humphrey, P.;
Johnson, D., On the aging of oxygen plasma-treated polydimethylsiloxane surfaces. J. Colloid Interface Sci. 1990, 137 (1), 11-24; (b) Hillborg, H.; Sandelin, M.; Gedde, U. W., Hydrophobic recovery of polydimethylsiloxane after exposure to partial discharges as a function of crosslink density. Polymer 2001, 42 (17), 7349-7362; (c) Kim, J.; Chaudhury, M. K.; Owen, M. J., Hydrophobic Recovery of Polydimethylsiloxane Elastomer Exposed to Partial Electrical Discharge. J. Colloid Interface Sci. 2000, 226 (2), 231-236; (d) Hillborg, H.; Gedde, U. W., Hydrophobicity recovery of polydimethylsiloxane after exposure to corona discharges. Polymer 1998, 39 (10), 1991-1998.
15. (a) Hillborg, H.; Tomczak, N.; Olah, A.; Schonherr, H.; Vancso, G. J., Nanoscale hydrophobic recovery: A chemical force microscopy study of UV/ozone-treated cross-linked poly(dimethylsiloxane). Langmuir 2004, 20 (3), 785-794; (b) Fritz, J. L.; Owen, M. J., Hydrophobic recovery of plasma-treated polydimethylsiloxane. J. Adhes. 1995, 54 (1-2), 33-45.
16. Brook, M. A.; Wang, Y.; Chen, Y. Surface-Modifying Silicone Elastomers. United States Patent Publication No. US 2012/0226001.
17. Sia, S. K.; Whitesides, G. M., Microfluidic devices fabricated in Poly(dimethylsiloxane) for biological studies. ELECTROPHORESIS 2003, 24 (21), 3563-3576.
18. Gong, M. M.; MacDonald, B. D.; Nguyen, T. V.; Sinton, D., Hand-powered microfluidics: A membrane pump with a patient-to-chip syringe interface. Biomicrofluidics 2012, 6 (4).
19. Li, J. X.; Wang, X.; Cheng, C.; Wang, L. M.; Zhao, E.; Wang, X. K.; Wen, W. J., Selective modification for polydimethylsiloxane chip by micro-plasma. J. Mater. Sci. 2013, 48 (3), 1310-1314.
20. Massey, S.; Duboin, A.; Mantovani, D.; Tabeling, P.; Tatoulian, M., Stable modification of PDMS surface properties by plasma polymerization: Innovative process of allylamine PECVD deposition and microfluidic devices sealing. Surf. Coat. Technol. 2012, 206 (19-20), 4303-4309.
21. Beal, J. H. L.; Bubendorfer, A.; Kemmitt, T.; Hoek, I.; Arnold, W. M., A rapid, inexpensive surface treatment for enhanced functionality of polydimethylsiloxane microfluidic channels. Biomicrofluidics 2012, 6 (3).
22. (a) Almutairi, Z.; Ren, C. L.; Simon, L., Evaluation of polydimethylsiloxane (PDMS) surface modification approaches for microfluidic applications. Colloid Surf. A-Physicochem. Eng. Asp. 2012, 415, 406-412; (b) Keefe, A. J.; Brault, N, D.; Jiang, S. Y., Suppressing Surface Reconstruction of Superhydrophobic PDMS Using a Superhydrophilic Zwitterionic Polymer. Biomacromolecules 2012, 13 (5), 1683-1687.
23. Peters, M. A.; Belu, A. M.; Linton, R. W.; Dupray, L.; Meyer, T. J.; DeSimone, J. M., Termination of Living Anionic Polymerizations Using Chlorosilane Derivatives: A General Synthetic Methodology for the Synthesis of End-Functionalized Polymers. J. Am. Chem. Soc. 1995, 117, 3380-3388.
24. Gonzaga, F.; Grande, J. B.; Brook, M. A., Morphology-Controlled Synthesis of Poly(oxyethylene)silicone or Alkylsilicone Surfactants with Explicit, Atomically Defined, Branched, Hydrophobic Tails. Chem. Eur. J. 2012, 18 (5), 1536-1541.
25. Keddie, D. J.; Grande, J. B.; Gonzaga, F.; Brook, M. A.; Dargaville, T. R., Amphiphilic Silicone Architectures via Anaerobic Thiol-Ene Chemistry. Org. Lett. 2011, 13 (22), 6006-6009.
26. Clayden, J.; Greeves, N.; Warren, S., Organic Chemistry. 2nd ed.; Oxford University Press: 2012.
27. Gonzaga, F.; Yu, G.; Brook, M. A., Versatile, efficient derivatization of polysiloxanes via click technology. Chem. Commun. 2009, (13), 1730-1732.
28. Brook, M. A., Replacing H with Si: Silicon-Based Reagents. In Silicon in Organic, Organometallic and Polymer Chemistry, Wiley: New York, 2000; pp 189-255.
29. Wuts, P. G. M.; Greene, T. W., Greene's Protective Groups in Organic Synthesis. 4th ed.; Wiley-Interscience: New Jersey, 2006.
30. Kocienski, P. J., Protecting Groups 3rd ed.; Thieme: 2005.
31. Brook, M. A. Silicon in Organic, Organometallic and Polymer Chemistry, Wiley: New York, 2000.
32. Hill, R. M., Siloxane Surfactants. In Silicone Surfactants, Hill, R. M., Ed. Marcel Dekker, Inc.: New York, 1999; p 360.
33. Lee, J. N.; Park, C.; Whitesides, G. M., Solvent Compatibility of Poly(dimethylsiloxane)-Based Microfluidic Devices. Anal. Chem. 2003, 75 (23), 6544-6554.
34. Fawcett, A. S.; Grande and Michael A. Brook, Very Rapid, Metal-Free Room Temperature Vulcanization Produces Silicone Elastomers, J. Polym. Sci. A: Polym. Chem. 2013, 51, 644-652.

1. A compound of the formula (I) or (II): 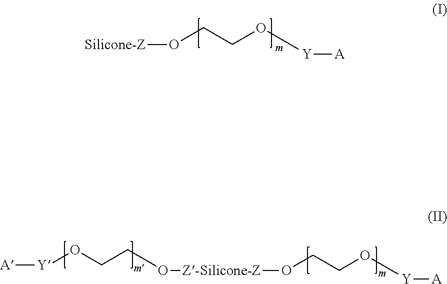
wherein:
m and m′ are, independently, an integer from 2 to 20;
Silicone is a straight or branched chain silicone polymer;
Y is a linker moiety selected from a direct bond,
—(CH₂)ₚ—, —(CH₂)_{p′}S—(CH₂)ₚ—, —C(O)—, —(CH₂)ₚC(O)—, —C(O)O—, —C(O)NH—, —(CH₂)ₚO—, —(CH₂)ₚC(O)O—, —(CH₂)ₚOC(O)—, —(CH₂)ₚOC(O)O— and —(CH₂)ₚOC(O)NH—;
Y′ is a linker moiety selected from a direct bond,
—(CH₂)_{p′}—, —(CH₂)_{p′}S—(CH₂)_{p′}—, —C(O)—, —C(O)(CH₂)ₚ—, —OC(O)—, —NHC(O)—, —O(CH₂)_{p′}—, —C(O)O(CH₂)_{p′}—, —OC(O)(CH₂)_{p′}—, —OC(O)O(CH₂)_{p′}- and —NHC(O)(CH₂)_{p′}—;
Z is a linker moiety selected from —(CH₂)ₙ—, —(CH₂)_{n′}S—(CH₂)ₙ—, —(CH₂)ₙtriazoleC(O)—, —(CH₂)ₙC(O)—, —O(CH₂)ₙ—, —(CH₂)ₙOC(O)—, and —OC(O)(CH₂)ₙ—;
Z is a linker moiety selected from —(CH₂)_{n′}—, —(CH₂)_{n′}S—(CH₂)ₙ—, —C(O)triazole(CH₂)_{n′}—, —C(O)(CH₂)_{n′}—, —(CH₂)_{n′}O—, —C(O)O(CH₂)_{n′}—, —(CH₂)_{n′}C(O)O—;
n and n′ are, independently, an integer from 1 to 6;
p and p′ are, independently, an integer from 1 to 6;
A and A′ are independently selected from C₁₋₂₀alkyl, a trisiloxane, a tetrasiloxane, a pentasiloxane, a hexasiloxane, a heptasiloxane, a functional group that is displaceable by a nucleophile or an electrophile and 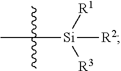
and R¹, R² and R³ are, independently, selected from C₁₋₂₀alkyl, C₃₋₁₄cycloalkyl and C₆-14aryl.

2. (canceled)

3. The compound of claim 1, wherein the straight chain silicone polymer comprises from about 10 to about 50 D monomeric repeat units.

4. (canceled)

5. The compound of claim 1, wherein the branched chain silicone polymer comprises a mixture of at least two of M (Me₃SiO), D (Me₂SiO), T (MeSiO_{3/2}) and Q (SiO_{4/2}) monomeric repeat units.

6. The compound of claim 5, wherein the branched chain silicone polymer comprises a total number of M, D, T, Q units that is from about 10 to 50 monomeric repeat units.

7. (canceled)

8. The compound of claim 1, wherein, in the compounds of Formula I, silicone-Z is selected from: 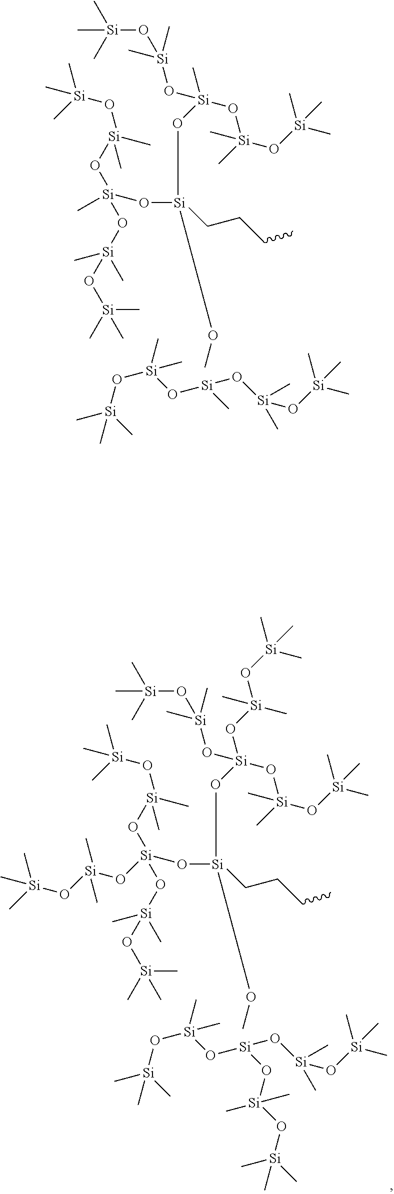
wherein [symbol] , represents the point of attachment of the silicon-Z.

9. The compound of claim 1, wherein, in the compounds of Formula I, the branched silicone is: 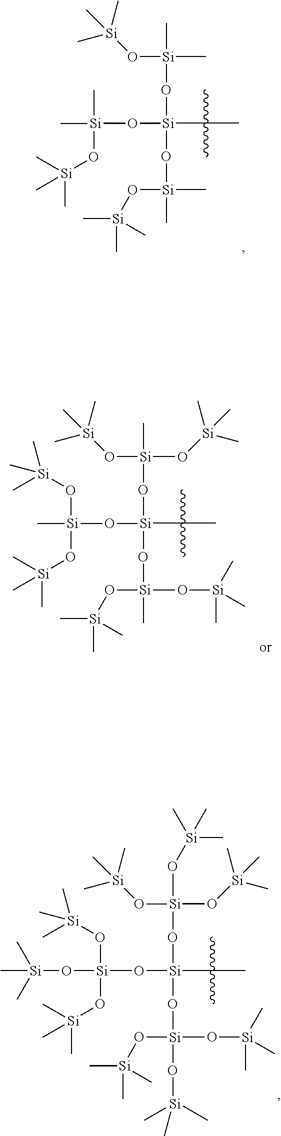
wherein 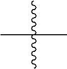
represents the point of attachment the branched silicone.

10. The compound of claim 1, wherein:
Y is a direct bond or —(CH₂)ₚ—;
Y′ is a direct bond or —(CH₂)_{p′}—;
p and p′ are, independently, an integer from 1 to 3;
A and A° are, independently, 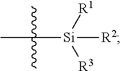
and
R¹, R² and R³ are independently selected from C₁₋₁₀-alkyl, C₅₋₆-cycloalkyl and phenyl.

11.-13. (canceled)

14. The compound of claim 1, wherein Y-A and Y′-A′ are, independently, selected from: 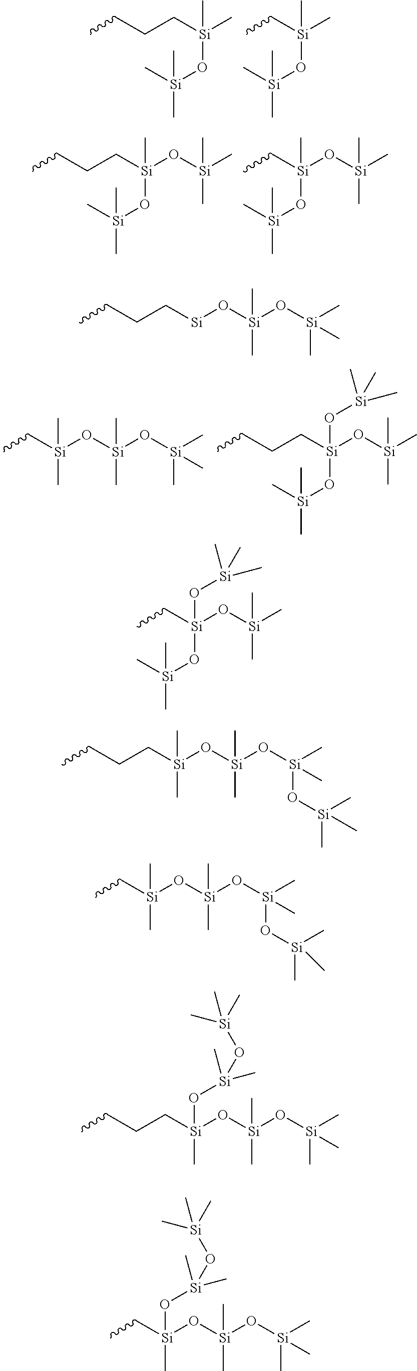 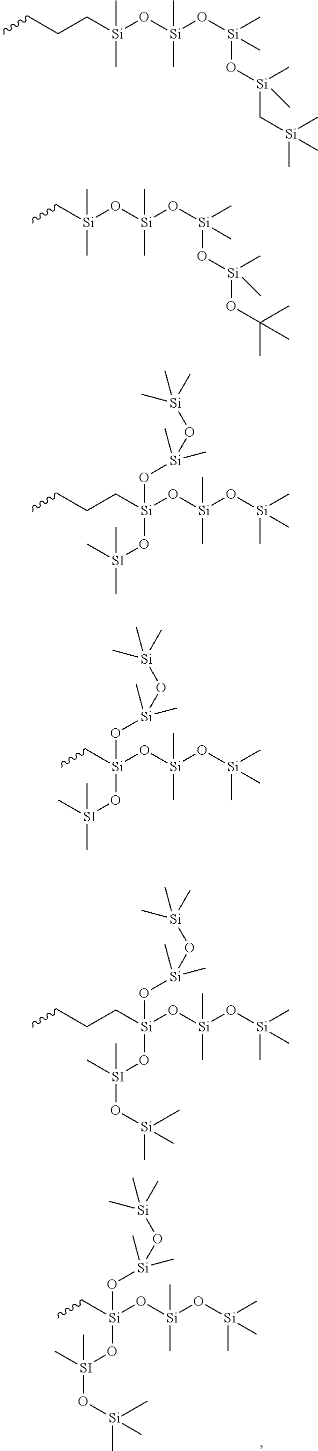
wherein [symbol] represents the point of attachment of Y-A and Y′-A′.

15. The compound of claim 1, having the formula 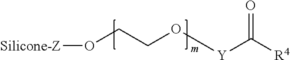
wherein
R⁴ is C₁₋₂₀alkyl or an activating group.

16. The compound of claim 1, having the formula 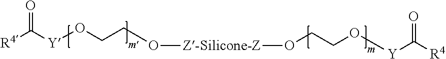
wherein:
R⁴ and R^{4′} are, independently, C₁₋₂₀alkyl or an activating group.

17.-18. (canceled)

19. The compound of claim 1, wherein m and m′ are independently 5, 6, 7, 8, 9, 10, 11 or 12.

20. (canceled)

21. The compound of claim 1, having a structure selected from:

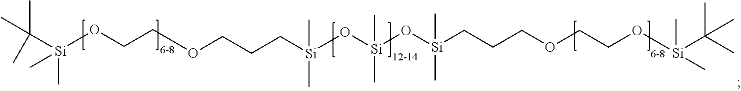

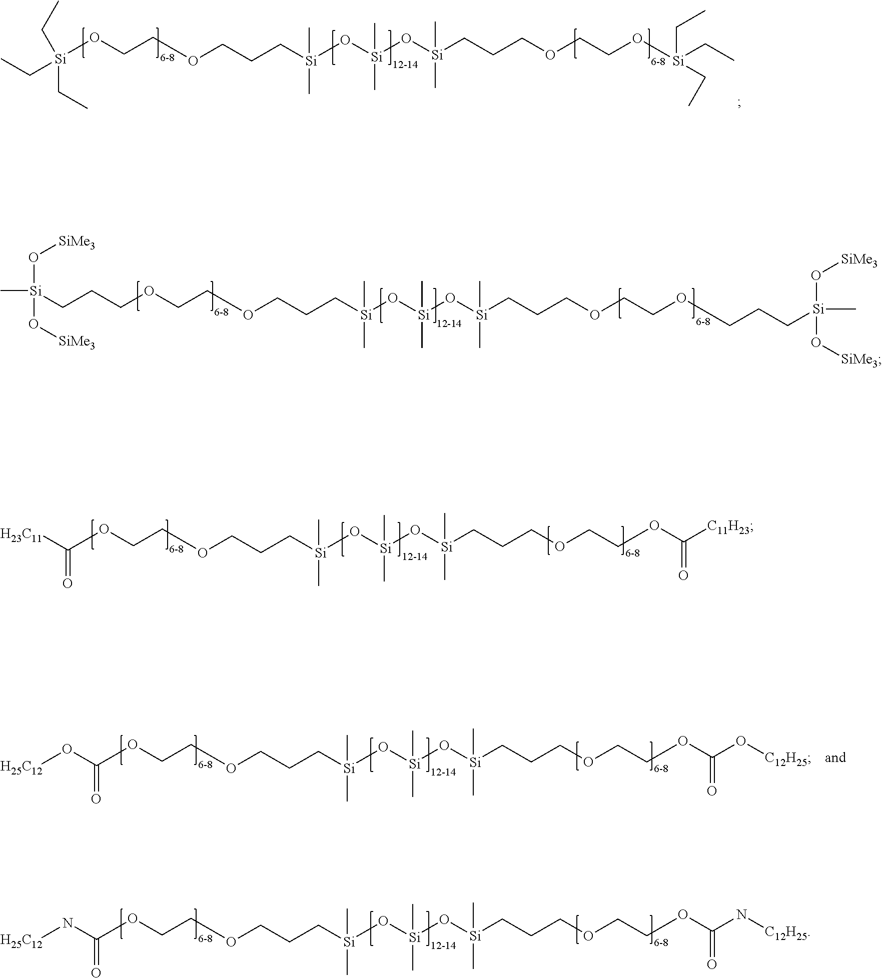

22. A process for surface-modifying a silicone elastomer, the process comprising:
(a) mixing one or more of the compounds of Formula (I) and/or (II) of claim 1, either neat or as a dispersion or solution, with a pre-cured silicone elastomer; and
(b) allowing the mixture of pre-cured silicone elastomer and compounds of the Formula (I) and/or (II) to cure.

23. The process of claim 22, wherein the concentration of the one or more compounds of Formula (I) and/or (II) is from about 1 to about 20% (w/w).

24. The process of claim 22, wherein the solution of the one or more compounds of Formula (I) and/or (II) is prepared using at least one solvent selected from THF, dichloromethane and toluene or related aprotic organic solvents, or low molecular weight silicone oils, like (Me₂SiO)₄ and (Me₂SiO)₅, or mixtures thereof.

25.-26. (canceled)

27. The process of claim 22, wherein the surface modification allows for covalent attachment of nucleophiles comprising S, N and/or O to the silicone elastomer.

28. The process of claim 27, wherein the nucleophile is a biological molecule.

29. A process for surface modifying a silicone elastomer, the process comprising:
(a) soaking a silicone elastomer in a solution or dispersion of one or more of the compounds of Formula (I) and/or (II) of claim 1 under conditions to produce a swollen elastomer; and
(b) drying the swollen silicone elastomer to produce a surface-modified silicone elastomer.

30. The process of claim 29, wherein the concentration of the compound of Formula (I) and/or (II) added to the elastomer formulations is from about 1 to about 30% (w/w).

31. A silicone elastomer that has been surface-modified by physical adsorption of one or more of the compounds of Formula (I) and/or (II) of claim 1.

32.-33. (canceled)
